(19) United States
(12) Patent Application Publication
(10) Pub. No.: US 2008/0201371 A1
(43) Pub. Date: Aug. 21, 2008

(54) Information delivery system, information delivery method, delivery device, node device, and the like

(75) Inventor: Atsushi Murakami, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/010,164

(22) Filed: Jan. 22, 2008

(30) Foreign Application Priority Data
Feb. 15, 2007 (JP) 2007-034369

(51) Int. Cl. G06F 17/30

(52) U.S. Cl. 707/104.1; 707/E17.089

(57) ABSTRACT

The present invention is to provide for example a node device that receives content catalog information having attribute information and delivered from a delivery device in an information delivery system, the nodes being mutually communicable through a network and divided into a plurality of groups, the node device including:
a new content catalog receiving means for receiving new content catalog information, delivered from the delivery device and having attribute information;
a new content catalog saving means;
a condition information saving means for saving the grouping condition and presentation time information;
a group judgment means for judging on the basis of the grouping condition;
a presentation time judgment means; and
a content catalog presentation setting means for presenting the new content catalog information after the presentation time arrives.

### CROSS REFERENCE TO RELATED APPLICATIONS

The present application claims priority from Japanese Patent Application NO. 2007-034369, which was filed on Feb. 15, 2007, the disclosure of which is herein incorporated by reference in its entirety.

### BACKGROUND OF THE INVENTION

1. Field of the Invention

The present invention relates to a peer to peer (P2P) type information communication system including a plurality of node devices, mutually connected through a network, especially relates to a technical field of a content delivery system and the like where a plurality of data are distributed and saved in a plurality of node devices.

2. Related Art

There is known, as this type of content delivery system, a system to which content data are distributed and allocated (distribution saving) in a plurality of node devices. In such the system, resistance to failure and distribution of access are enhanced. Existence of content data thus distributed can be efficiently searched by use of, for example, a distributed hash table (hereinafter referred to as a DHT) disclosed in Patent Document 1. The DHT is saved in each of node devices. There is registered in the DHT node information indicative of a plurality of node devices to be a transmission destination of various messages (for example, including an IP address and a port number).

Then, each of the node devices includes content catalog information describing attribute information of content data thus distributed and saved (for example, content name, genre, artist name, and the like) and transmits a message (a query) for searching for (finding) location of desired content data to other node devices on the basis of the attribute information described in the content catalog information. Then, the message is transferred to a node device which manages the content data by a plurality of relay node devices according to the DHT and obtains node information from the node device which manages the content data to which the message finally reaches. Thus, the node device which transmitted the message requests the content data to a node device saving the searched content data and can receive the content data.

Meanwhile, when new content data are inputted and saved in the above-mentioned system, it is necessary that new content data catalog information having attribute information of the content data described in it are delivered to all the node devices.

### [Patent Document 1] Japanese Unexamined Patent Publication No. 2006-197400

### SUMMARY OF THE INVENTION

However, when new content catalog information is delivered to all the node devices at a time, many node devices try to acquire (download) new content data having the new content catalog information having attribute information described in it. Therefore, the message (query) concentrates on a node device which manages location of the new content data. Further, request for the new content data concentrates to a node device saving the data. Therefore, there is concern that the device load and network load are increased. Further, a waiting time caused by the above may result in user's dissatisfaction. Especially, immediately after delivery of new content catalog information, because new content data described therein has just been inputted, there are small number of node devices which have acquired and are saving the new content data. It is assumed that there are not enough number of node devices, saving the new content data, to satisfy requests from many node devices.

In consideration of the above-mentioned problems, an object of an illustrative, non-limiting embodiment of the present invention is to provide an information delivery system, an information delivery method, a delivery device, a node device, and the like, which can suppress device load and network load caused by concentration of access even when new content catalog information is delivered.

According to a first aspect of an illustrative, non-limiting embodiment of the present invention, there is provided a node device which receives content catalog information, having attribute information of content data, acquirable by each of a plurality of node devices, described in it and being delivered from a delivery device, in an information delivery system that includes the plurality of nodes, the nodes being mutually communicable through a network and divided into a plurality of groups in response to a predetermined grouping condition, the node device including:

a new content catalog receiving means for receiving new content catalog information, delivered from the delivery device and having attribute information of new content data to be newly acquirable by each of the node devices;

a new content catalog saving means for saving the new content catalog information thus received;

a condition information saving means for saving condition information indicative of the grouping condition and presentation time information stipulating a presentation time when the new content catalog information is to be presented to a user with respect to each group;

a group judgment means for judging a group, to which the own node belongs, on the basis of the condition information;

a presentation time judgment means for judging whether or not there becomes the presentation time corresponding to a group, to which the own node device belongs, after receiving the new content catalog information on the basis of the presentation time information; and

a content catalog presentation setting means for setting up the new content catalog information thus saved to be in a condition that presentation to a user is enabled in a case where it is judged that there becomes the presentation time corresponding to the group, to which the own node device belongs.

According to this invention, new content catalog information delivered from a delivery device is received and saved, and when there becomes a presentation time corresponding to a group, to which the own node device belongs, the new content catalog information thus saved is set up to be in a condition that presentation to a user is enabled. Therefore, device load and network load caused by concentration of access to a device can be suppressed as much as possible, and waiting time for a user can be minimized.

### BRIEF DESCRIPTION OF THE DRAWINGS

In the accompanying drawings:

FIG. 1 is a view showing an example of a connection mode of each node device in a contents delivery system according to the present embodiment.

FIG. 2 is a view showing an example that a routing table is made.

FIG. 3 is a view showing an example of a routing table.

FIG. 4 is a conceptual diagram showing an example of a flow of a publish message, transmitted from a content retaining node in a node ID space of a DHT.

FIG. 5 is a conceptual diagram showing an example of display mode transition of a music catalog.

FIG. 6 is an example of a routing table retained by a node X, being a catalog management node.

FIG. 7 is a pattern diagram typically showing a catalog delivery message.

FIG. 8 is a view showing how DHT multicast is performed.

FIG. 9 is a view showing how DHT multicast is performed.

FIG. 10 is a view showing how DHT multicast is performed.

FIG. 11 is a view showing how DHT multicast is performed.

FIG. 12 is a view showing an example of an estimated popularity curve of new content data.

FIG. 13 is a view showing a schematic configuration example of a node.

FIG. 14 is a flowchart showing a new content catalog information delivery process in a control unit 11 of the catalog managing node.

FIG. 15 is a flowchart showing process in the control unit 11 of a node for receiving new content catalog information.

FIG. 16 is a flowchart showing details of catalog delivery message receiving process shown in FIG. 15.

FIG. 17 is a view showing an example of content of a grouping condition table.

FIG. 18 is a view showing an example of a case where a list of new content data described in new content catalog information is pop-up displayed on a display screen of a display unit 16.

FIG. 19 is a flowchart showing presentation instruction message delivery process in the control unit 11 of the catalog management node.

FIG. 20 is a flowchart showing process in the control unit 11 of a node for receiving the presentation instruction message.

FIG. 21 is a flowchart showing the presentation instruction message delivery process in the control unit 11 of the catalog managing node when a value of top digit of a node ID is set to be a factor for grouping condition.

FIG. 22 is a flowchart showing presentation instruction message delivery process in the catalog managing server.

### DESCRIPTION OF THE PREFERRED EMBODIMENTS

Preferred embodiments of the present invention will be described as follows. Hereinafter, each designation of numerical reference in the drawings is typically as follows: A to Z: node; 8: network; 9: overlay network; 11: control unit; 12: storage unit; 13: buffer memory; 14: decoder; 15: image processing unit; 16: display unit; 17: audio processing unit; 18: speaker; 20: communication unit; 21: input unit; 22: bus; and S: content delivery system.

Hereafter, best embodiments of the present invention will be explained on the basis of figures. Here, embodiments explained below are modes of carrying out the present invention in a case where the present invention is applied to a content delivery system utilizing a DHT.

### 1. Configuration and the Like of Content Delivery System

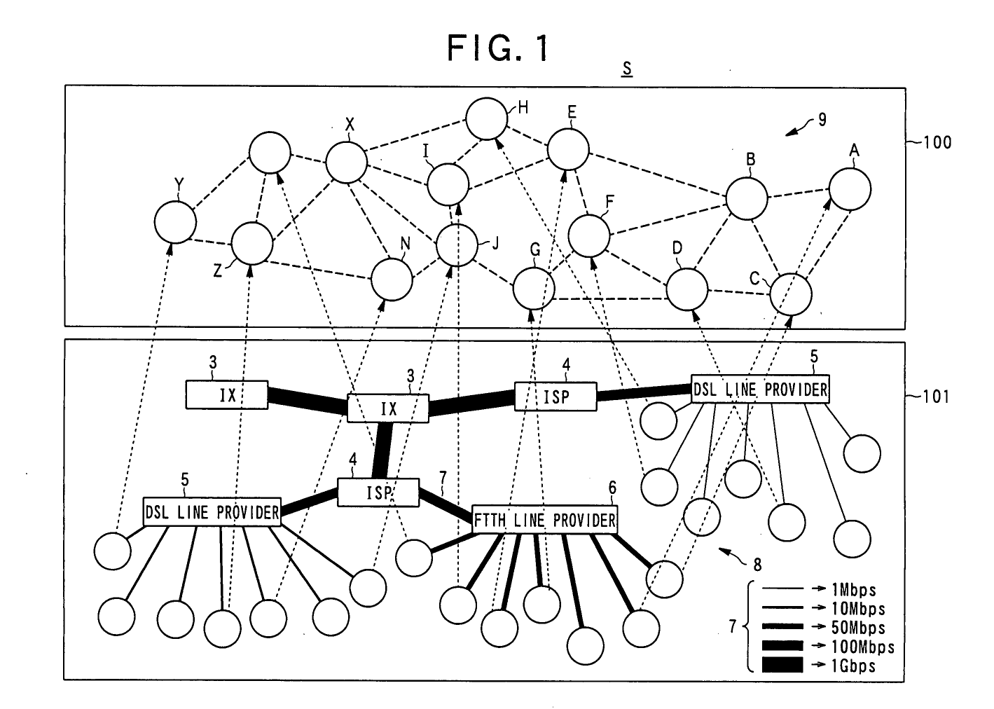

First, with reference to FIG. 1, schematic configuration and the like of a content delivery system as an example of an information delivery system will be explained.

FIG. 1 is a view showing an example of connection status of each node device in a content delivery system according to the present embodiment.

As shown in a lower rectangular frame 101 in FIG. 1, a network 8 (network in real world) of the Internet or the like is configured by an internet exchange (IX) 3, internet service provider (ISP) 4, digital subscriber line provider (or their device) 5, fiber to home line provider ('s device) 6, and communication line (for example, such as a telephone line or an optical cable) 7 and the like. Here, in the network (communication network) 8 in the example of FIG. 1, routers for transferring a message (packet) are appropriately inserted (not shown).

A content delivery system S is configured by a plurality of node devices A, B, C . . . X, Y, Z . . . which are connected each other via network 8 such as a communication means (hereinafter referred to as a “node”) and is a peer to peer network system. To each of the node devices A, B, C . . . X, Y, Z . . . , unique manufacturing number and internet protocol (IP) address as destination information are assigned. Such the manufacturing number and IP address do not overlap among a plurality of nodes.

Next, an algorithm utilizing a distributed hash table (hereinafter referred to as a “DHT”) according to the present embodiment will be explained.

In the above-mentioned content delivery system S, the nodes mutually know IP address or the like in exchanging information.

For example, in a system where content is shared among each node devices, it is a simple method that each node mutually knows IP addresses of all the node devices participating in the network 8. However, when there are tens or hundreds of thousand of terminals, it is not realistic to memorize the IP addresses of all the nodes. Further, when power is thrown into or out of an arbitrary node device, it is required for each of the node devices 1 to frequently update IP address of the arbitrary node, and therefore it is difficult to operate the system.

Accordingly, there is devised a system that one node memorizes (saves) necessary and minimum IP addresses of nodes among all the nodes, and information is transferred between nodes and reaches with respect to a node with its IP address unknown (not saved).

As an example of such a system, an overlay network 9 shown in the upper rectangular frame 100 of FIG. 1 is configured by an algorithm using DHT. In other words, the overlay network 9 means a network that configures a virtual network, formed by using an existing network 8.

There is a premise that an overlay network 9, configured by an algorithm in use of DHT, exists in this embodiment. A node arranged on this overlay network 9 is referred to as a node participating in the overlay network 9. Here, participation in the overlay network 9 is carried out when a node not participating yet sends a participation request to an arbitrary node which has already participated in the network (for example, a contact node always participating in the overlay network 9).

Each node has a node ID as unique node identification information. The node IDs are hashed values including a given character number obtained by hashing, for example, an IP address or a manufacturing number by a shared hash function (for example, SHA-1), and are allocated and dispersed without deviation to an ID space. It is necessary that the node ID has a bit number enough to include maximum operation number of nodes. For example, when the number is a 128-bit number, the node device can operate node devices as many as 2̂128=340×10̂36.

As such, each of the node IDs obtained by a shared hash function in such a manner has a very low possibility of having an identical value when the IP address or the manufacturing number differs from each other. Because a know hash function is applicable thereto, detailed explanation thereof is omitted.

### [1.1 Creation Method of Routing Table Using DHT]

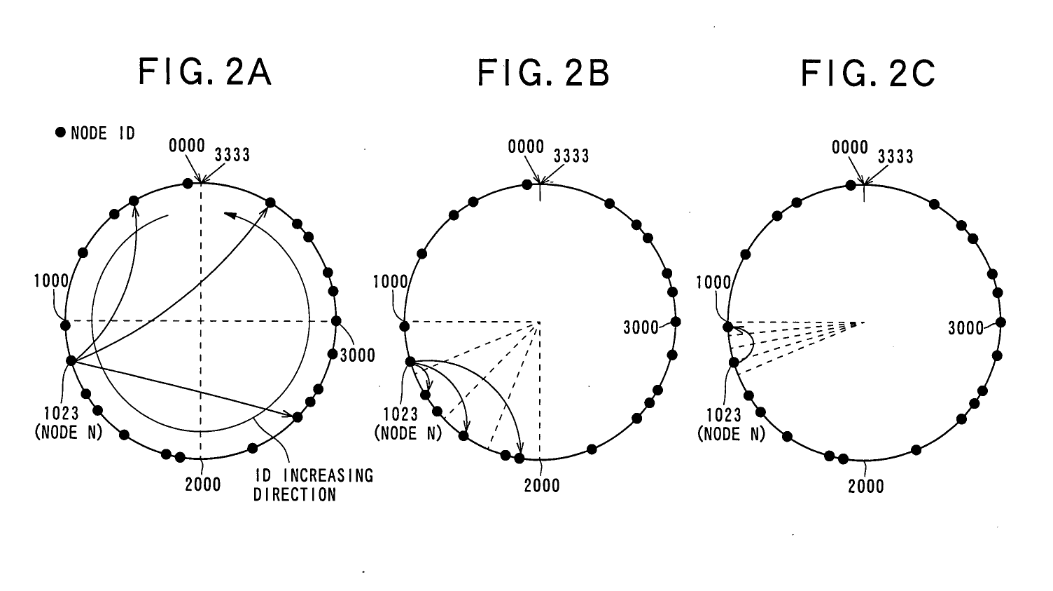

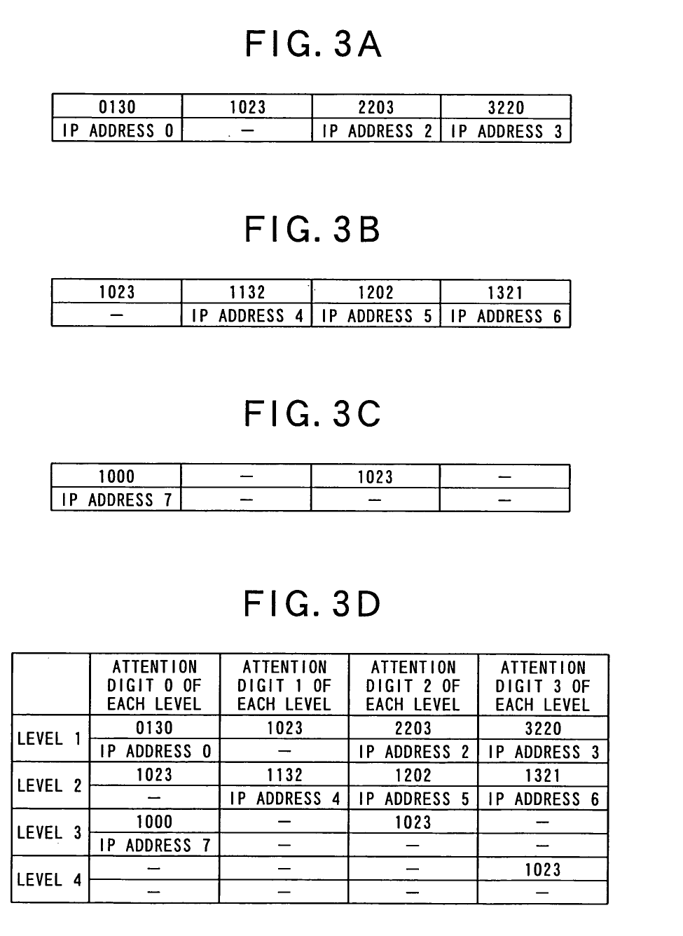

Next, with reference to FIGS. 2 and 3, an example of creation method of a routing table, being a content of DHT, will be explained.

FIG. 2 is a view showing an example of how a routing table is made, and FIG. 3 is a view showing an example of a routing table.

Since the node ID given to each of node devices 1 is generated by a shared hash function, as shown in FIGS. 2(A) to 2(C), it is assumed that the node IDs are dispersed and exist in an identical ring-shaped ID space without deviation. The figures show a case where a node ID of 8 bit is given. In the figures, a black dot designates a node ID, wherein the node ID increases along a counterclockwise direction.

First, as shown in FIG. 2 (A), an ID space is divided into several areas in compliance with a predetermined rule. Although ID space is frequently divided into sixteen (16) areas in a practical application. For easy of explanation, the space is divided into four, and the ID is expressed by quaternary number having a bit length of eight (8). There will be described about an example that a node ID of node N is “1023”, and a routing table of the node N is made.

### (Routing in Level 1)

When the ID space is divided into four, there are four areas where a maximum digit number differ from each other when expressed by quaternary number, such as “0XXX”, “1XXX”, “2XXX”, and “3XXX” (hereinafter, “X” is a natural number of from 0 to 3). Since the node ID of the node N is “1023”, the node N exists in a left lower area of “1XXX” in the figure.

Then, the node N arbitrarily selects each of nodes 1 existing in areas other than the area where the node N exists (that is, an area other than “1XXX”) as representative nodes and registers (saves) an IP address and the like (hereinafter, a port number is actually included) of the node in each column of a table in level 1. FIG. 3(A) is an example of a table in level 1. The second raw in a table of level 1 indicates the own node device N, and therefore it is unnecessary to save the IP address.

### (Routing in Level 2)

Next, as shown in FIG. 2 (B), among four areas obtained by dividing using the above routing, an area where the own node device N exists is further divided into four to make four more areas, “10XX”, “11XX”, “12XX”, and “13XX”.

Then, in a manner similar to the above, each of nodes existing in an area where the node N does not exist are arbitrarily selected as representative nodes, and IP addresses and the like of the node IDs are registered in each column in a table of level 2. FIG. 3 (B) is an example of a table in level 2. The first raw indicates the own node device N and therefore it is unnecessary to register the IP address.

### (Routing in Level 3)

Further, as shown in FIG. 2(C), among four areas obtained by dividing using the above routing, an area where the own node N exists is further divided into four to make four more areas, “100X”, “101X”, “102X”, and “103X”. Then, in a manner similar to the above, nodes existing in an area where the node N does not exist are arbitrarily selected as representative nodes, and IP addresses and the like of the nodes are registered in each column in a table (table entry) in level 3. FIG. 3 (C) is an example of a table of level 3. The third raw indicates the own node device N and therefore it is unnecessary to register the IP address thereof and the second and fourth rows are left blank because there exists no node devices in these areas.

Thus because routing tables are made in a similar manner to the above up to level 4 as shown in FIG. 3 (D), all IDs of eight (8) bit can be covered. The higher the level is, the more blank spaces appear on the table.

The routing table, obtained according to the method (rule) explained above, is created and possessed by all the nodes (creation of such a routing table is performed when, for example, a non-participant node participates in the overlay network 9, but this is not directly related to the present invention and therefore detailed explanation thereof is omitted).

In other words, each node correlates IP address and the like of one node, belonging to each area divided into a plurality of numbers with each area, and stipulates them as one stage (level). Further, the area to which the own node belongs is divided into a plurality of areas. The nodes memorize a routing table stipulating IP address or the like of one node, respectively belonging to the areas thus divided, as a next stage (level) while making the IP address or the like correlate to each of the areas.

Number of levels is determined depending on the digit number of a node ID, and number of attention character is determined depending on number of radix (base number). Specifically, in case of 16-character hexadecimal, ID is in 64-bit and (alpha-) numeral in an attention character in level 16 is 0 to F. In explanation of a routing table described later, a part indicative of a number of an attention character in each level is simply referred to as a “row”.

### [1.2 Saving and Search Methods of Content Data]

Next, saving and search methods for content data acquirable in the content delivery system S will be explained.

In the overlay network 9, various content data (for example, a movie or music) are distributed to a plurality of nodes and saved (stored) (in other words, content data are copied and replica which is copied information is distributed and saved).

For example, content data of a movie titled XXX are saved in nodes A and D. Meanwhile, content data of a movie titled YYY are saved in nodes B and C. In such a manner, content data are distributed and saved in a plurality of nodes (hereinafter referred to as “content retaining node”).

Further, in the content data, information such as content name (title) and content ID (content identification information unique to each content) are added. The content ID is generated by hashing content name+arbitrary numerical value (or top some bytes of the content data) by the hash function, which is used in common when obtaining the node ID (allocated on the same ID space as node ID). Or a system operator may give a unique ID value (the same bit length as node ID) to each content. In this case, association between content name and content ID is written in later-described content catalog information and the information is delivered to each of the nodes.

Further, location of content data thus distributed and saved, that is, IP address and the like of a node saving the content data, and index information including a combination of the content ID and the like corresponding to the content data are saved and managed by a node that manages location of the content data (hereinafter, referred to as a “root node” or a “root node of content (content ID)”) or the like.

For example, index information of content data of a movie titled XXX is managed by a node M, which is a root node of the content (content ID) and index information of content data of a movie titled YYY is managed by a node 0 that is a root node of the content (content ID).

That is, root nodes are classified for each content, and therefore load is distributed. Further, in a case where identical content data (having an identical content ID) are saved in a plurality of content retention nodes, index information of such the content data can be managed by one root node. Further, such the root node is determined to be a node including, for example, a node ID that is closest to content ID (for example, upper digits match more).

A node (content retention node) having the content data thus saved notifies the root node of an event that the node has saved the content data. For that purpose, a publish (registration notification) message (a registration message indicating request for registration of IP address and the like because content data has been saved) including content ID of the content data, IP address and the like of the own node is generated, and the publish message is transmitted to the root node. Thus, the publish message reaches the root node by a DHT routing using a key of content ID.

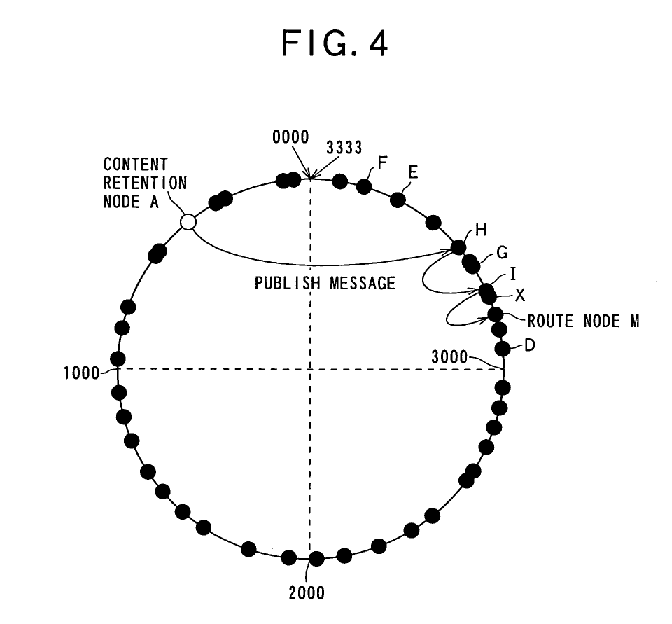

FIG. 4 is a conceptual diagram showing an example of a flow of a publish message, transmitted from a content retaining node.

In the example of FIG. 4, for example, a node A being a content retention node refers to a table of level 1 of an own DHT of the node A, acquires IP address and the like of, for example, a node H having a node ID closest to the content ID included in the publish message (for example, upper digits match more), and transmits the publish message to the IP address and the like.

On the contrary thereto, the node H receives the publish message, refers to a table of level 2 of the own DHT, acquires IP address and the like of, for example, a node I having a node ID closest to the content ID included in the publish message (for example, upper digits match more), and transfers the publish message to the IP address and the like.

Then, the node I receives the publish message, refers to a table of level 3 of the own DHT, acquires IP address and the like of, for example, a node M having a node ID closest to the content ID, included in the publish message (for example, a node ID of which top characters match the most), and transfers the publish message to the IP address and the like.

On the contrary thereto, the node M receives the publish message, refers to a table of level 4 of the own DHT, recognizes that the node ID closest to the content ID included in the publish message (for example, a node ID of which top characters much the most) is the own node M, that is, the own node M is a root node of the content ID, and registers (saves in index cache area) the index information including a pair of IP address and the like and content ID, included in the publish message.

Here, index information including a combination of IP address and the like and content ID is also registered (cached) in a node on a transfer route from a content retention node to a root node (hereinafter referred to as “relay node”, nodes H and I in the example of FIG. 4) (a relay node which caches index information in such a manner is referred to as a cache node).

Then, when a user of a node wants to acquire desired content data, a node that wishes to acquire the content data (hereinafter referred to as a “user node”) transmits a content location inquiry message including content ID of the content data selected by the user from content catalog information to other nodes according to a routing table of the own DHT. Thus, the content location inquiry message passes through (is transferred) some relay nodes by DHT routing having a key of content ID in a manner similar to the above-mentioned publish message and reaches a root node of the content ID. Then, the user node acquires (receives) index information of the above-mentioned content data from the root node, connects to a content retention node saving the content data on the basis of the IP address and the like, and is enabled to acquire (download) the content data from the content retention node. Here, the user node can acquire (receive) the IP address and the like from a relay node (cache node), which caches the same index information as the one saved by the root node, before the content location inquiry message reaches the root node.

### [1.3 Content of Content Catalog Information]

Next, content and the like of content catalog information will be explained.

To the content catalog information (also referred to as a content list), attribute information of content data which can be acquired by each node in the content delivery system S is associated with each content ID and described (also called registered).

As the attribute information, there can be listed, for example, content name (when the content is a movie, title of the movie; when the content is music, title of the music; and when the content is a broadcast program, title of the program), genre as an example of content type (when the content is a movie, animation, action, horror, comedy, love story, etc., when the content is music, rock, jazz, pops, classic, and etc.; and when the content is a broadcast program, drama, sports, news, movie, music, animation, variety, etc.), artist name (when the content is music, name of a singer or a group), cast (when the content is a movie or a broadcast program), director's name (when the content is a movie), quantity of data, time for replaying, etc.

Such attribute information is an element for a user to specify desired content data and can be used as a search keyword, being a search condition for searching for the desired content data out of a large quantity of content data.

For example, when a user inputs “jazz” as a search keyword, all the content data having attribute information matching “jazz” are searched, and attribute information of searched content data (for example, content name, genre, etc.) is presented to the user so as to be selectable.

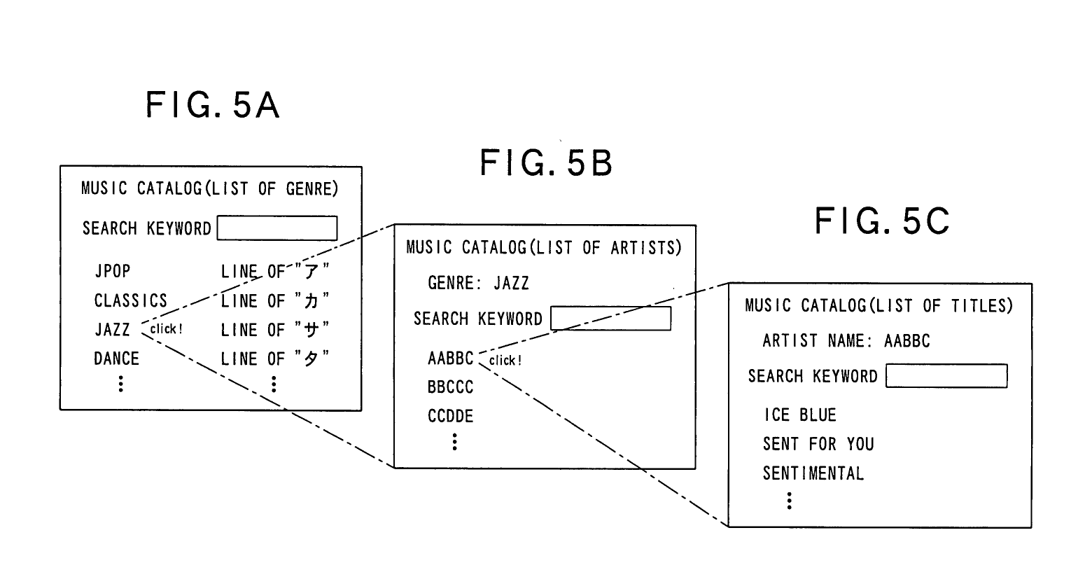

FIG. 5 is a conceptual diagram showing an example of display form transition of a music catalog. In such a music catalog (or may be a movie catalog), the above-mentioned content catalog information is built. In the example shown in FIG. 5 (A), from a displayed list of genre, for example, jazz is inputted as a search keyword and searched. As a result, as shown in FIG. 5 (B), an artist list corresponding to jazz is displayed and from the artist list, for example, an artist name “AABBC” is inputted as a search keyword. Resultantly, as shown in FIG. 5 (C), a list of titles of music corresponding to the artist (for example, sung or played by the artist) is displayed. Then, when a user selects a desired music title through an input unit from the list of titles of music, content ID of the music data (an example of content data) is acquired. As mentioned above, a content location inquiry message including the content ID is transmitted to the root node. Here, the content ID may not be described in content catalog information. In this case, each node may hash content name+arbitrary numerical value, included in the attribute information, using the above-mentioned commonly used hash function obtained by hashing the node ID described above.

Such content catalog information is managed by either a node managed by for example a system operator (hereinafter referred to as a “catalog management node” (an example of delivery device)) or a catalog management server (an example of delivery device).

Then, when new content data (that is, new content data to be newly acquirable by each node) is inputted into a certain node (saved for the first time) on the content delivery system S, new content catalog information where attribute information of the new content data is registered is made and delivered to all the nodes, participating in the overlay network 9. Here, content data once thrown in is acquired from a content retention node and copies of the content data will be saved as described above.

### [1.4 Delivery Method of Content Catalog Information]

New content catalog information thus newly made may be delivered to all the nodes participating in the overlay network 9 by means of one or a plurality of catalog management servers (in this case, a catalog management server saves an IP address or the like of a node to be delivered). However, by use of multicast using the DHT (hereinafter, referred to as a “DHT multicast”), it is possible to efficiently deliver new content catalog information to all the nodes participating in the overlay network 9.

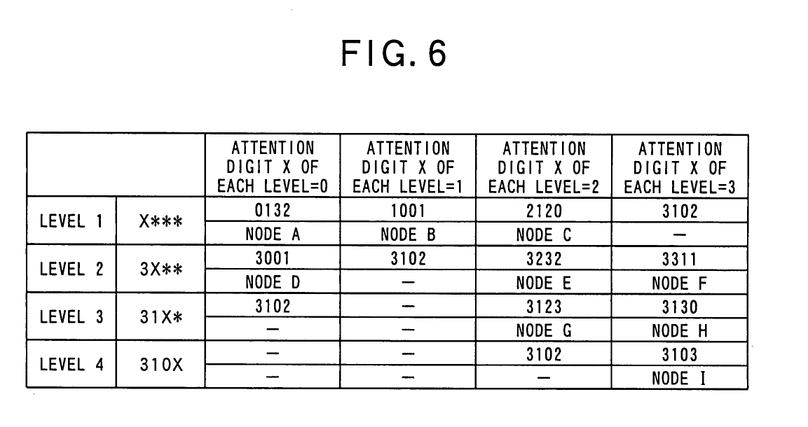

Here, with reference to FIGS. 6 to 11, delivery method of content catalog information by the DHT multicast will be explained.

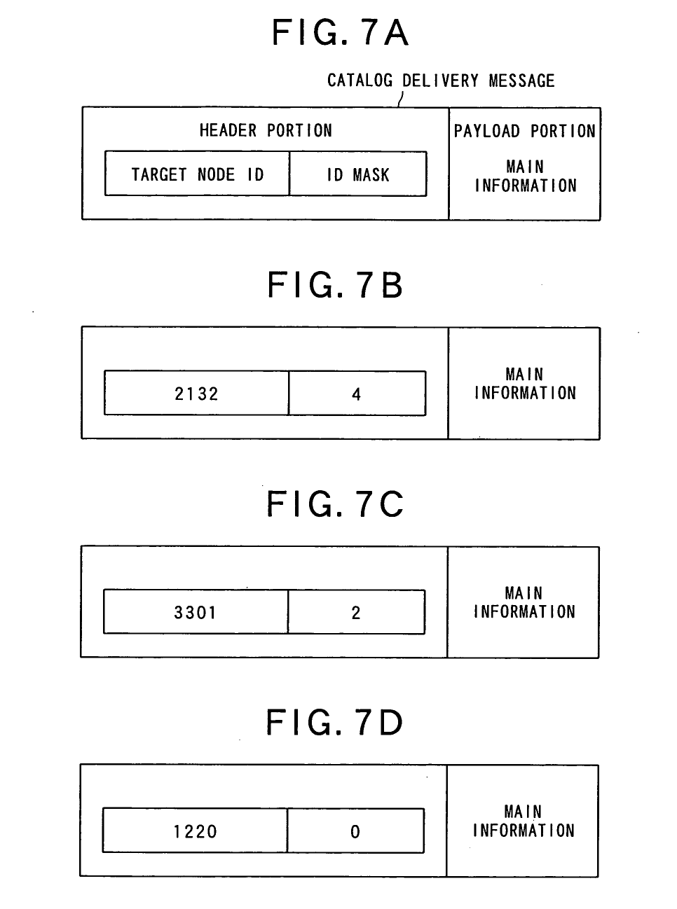

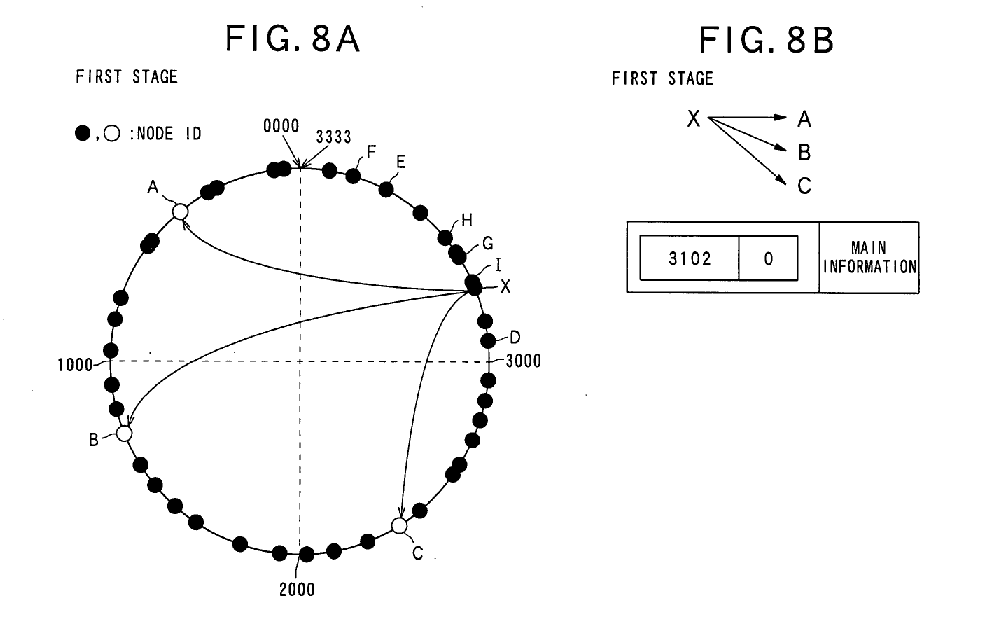

FIG. 6 is an example of a routing table retained by a node X which is a catalog managing node. FIG. 7 is a pattern diagram showing a catalog delivery message, and FIGS. 8 to 11 are views showing how DHT multicast is performed.

Here, it is assumed that the node X retains a routing table such as one shown in FIG. 6 and in a column corresponding to each area of levels 1 to 4 in the routing table, a node ID of any of nodes A to I (four digit quaternary number), an IP address and the like are saved.

As shown in FIG. 7 (A), a catalog delivery message includes a packet having a header part and a payload part. In the header part, a target node ID, an ID mask, IP address or the like of a node corresponding to the target node ID (not shown) are included, and main information having new content catalog information and the like is included in the payload part.

Here, relation between a target node ID and an ID mask will be explained in detail.

The target node ID is the same digit number as the node ID (in the example of FIG. 6, four digit quaternary number) for setting a node to be a transmission destination node, and according to a value of the ID mask, for example, sets a node ID of a node on a transmission source or a transfer source of a catalog delivery message or a node ID of a node on a transmission destination to be a transmission destination.

Further, the ID mask is provided to specify a valid digit number of a target node ID. By the valid digit number, a node ID of the target node ID having common valid digit number from upper grade is indicated. Specifically, the ID mask (a value of the ID mask) is an integer having a value of from 0 to the maximum digit number of the node ID. For example, in a case where the node ID is a four digit quaternary number, the ID mask becomes an integer of between 0 and 4.

For example, as shown in FIG. 7(B), in a case where a target node ID is “2132” and an ID mask value is “4”, all “four” digits of the target node ID are valid and a node having the node ID of “2132” solely becomes a transmission target of the catalog delivery message.

Further, as shown in FIG. 7 (C), in a case where a target node ID is “3301” and an ID mask value is “2”, an upper digit “2” of the target node ID is valid (node ID is “33**”), and all the nodes on a routing table having “33” as upper two digit numbers (lower two digit numbers may be any value) become targets to which the catalog delivery message is transmitted.

Further, as shown in FIG. 7 (D), when a target node ID is “1220” and an ID mask value is “0”, upper “0” digit of the target node ID is valid. Namely, any digit may be any value (therefore, a target node ID may be any value at this time), and all the nodes on a routing table become targets to which the catalog delivery message is transmitted.

Then, in a case where a node ID is a four digit quaternary number, DHT multicast transmitted from the node X, being a catalog management node, is carried out in steps from the first to fourth stages, as shown in FIGS. 8 to 11.

### (First Stage)

First, the node X sets up a node ID “3102” of the own node X to be a target node ID in the header part and ID mask to be “0”, to thereby generate a catalog delivery message including the header part and a payload part. Then, as shown in FIGS. 7 (A) and (B), the node X refers to the routing table shown in FIG. 6 and transmits the catalog delivery message to representative nodes (nodes A, B, and C) registered in each column (that is, belonging to each area) in a table of level “1”, the number “1” being acquired by adding “1” to the ID mask “0”.

### (Second Stage)

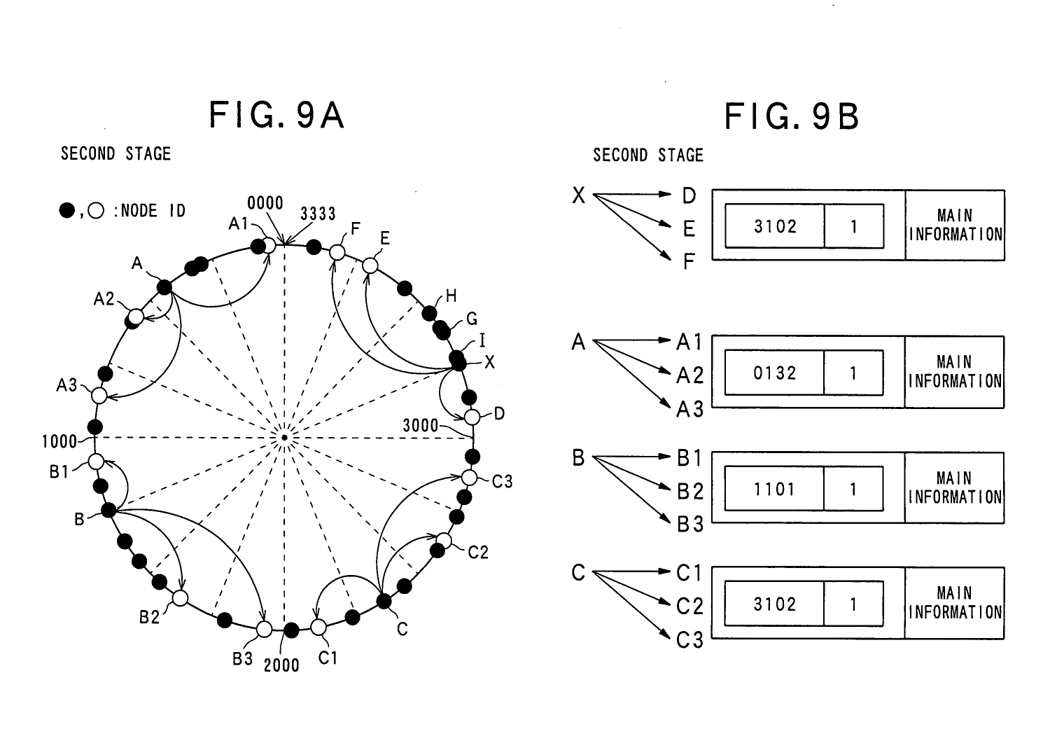

Next, the node X generates a catalog delivery message having the ID mask of “0” in the header part of the catalog delivery message converted to “1”. Here, since the target node ID is the node ID of the own node X, the target node ID is not changed. Then, the node X refers to the routing table shown in FIG. 6 and transmits the catalog delivery message to nodes registered in each column (nodes D, E, and F) in a table of level “2”, the number “2” being acquired by adding “1” to the ID mask “1”, as shown in a right upper area of a node ID space in FIG. 9 (A) and FIG. 9 (B).

Meanwhile, the node A that receives the catalog delivery message (a catalog delivery message corresponding to the area to which the own node belongs) from the node X in the first stage converts the ID mask “0” to “1” in the header part of the catalog delivery message and converts the target node ID “3102” to “0132”, being the own node ID, to thereby generate a catalog delivery message.

Then, the node A refers to a routing table of the own node (not shown) and, as shown in a left upper area of a node ID space in FIG. 9 (A) and FIG. 9 (B), transmits the catalog delivery message to each nodes (nodes A1, A2, and A3), registered in each column in a table of level “2”, the number “2” being acquired by adding “1” to the ID mask “1”.

In other words, the node A determines one (representative) node belonging to each area in a case where an area, to which the node A belongs, is further divided into a plurality of areas (“00XX”, “01XX”, “02XX”, and “03XX”) and transmits the catalog delivery message thus received to all the nodes thus determined (nodes A1, A2, and A3). Hereinafter, processes similar to the above are carried out.

In a manner similar thereto, as shown in a left lower area and a right lower area of a node ID space respectively in FIG. 9 (A) and FIG. 9 (B), nodes B and C which receive the catalog delivery message from the node X in the first stage respectively refer to own routing tables of the nodes B and C, generate a catalog delivery message, obtained by setting up an ID mask to be “1” and a target node ID to be the node ID of the node B or C, with respect to each of nodes (nodes B1, B2, B3, C1, C2, and C3) registered in each column in a table of level 2, and transmit the catalog delivery message.

### (Third Stage)

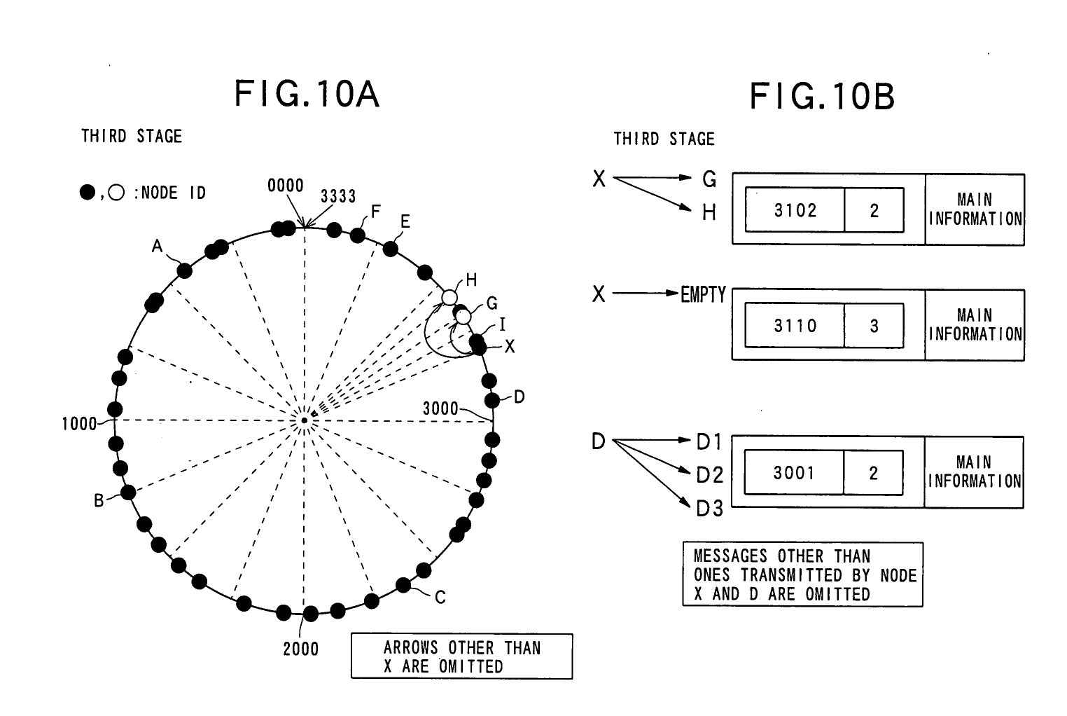

Next, the node X converts the ID mask “1” in the header part of the catalog delivery message to “2”, to thereby generate a catalog delivery message. Here, in a similar manner to the above, the target node ID is not changed. Then, the node X refers to the routing table shown in FIG. 6 and transmits the catalog delivery message to nodes registered in each column (nodes D, E, and F) in a table of level “3”, the number 3 being acquired by adding “1” to the ID mask “2”, as shown in right upper areas of node ID spaces in FIG. 10 (A) and FIG. 10 (B).

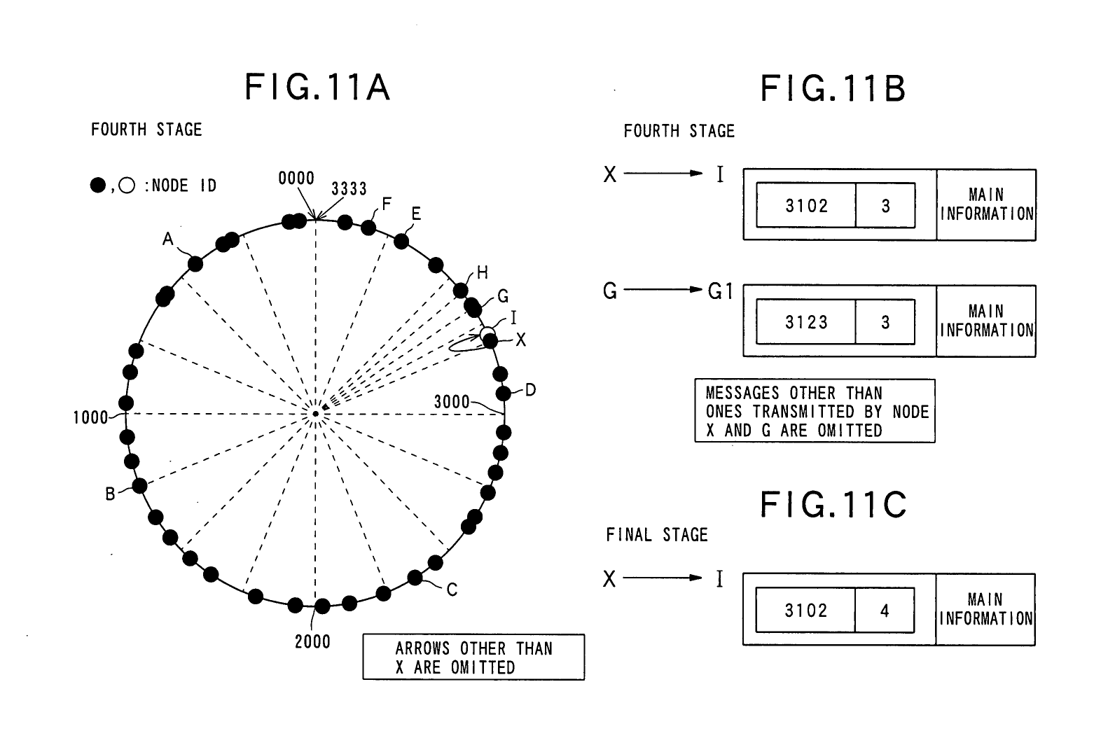

Meanwhile, in the second stage, the node D which received the catalog delivery message from the node X in the second stage converts the ID mask “1” to “2” in the header part of the catalog delivery message and converts the target node ID “3102” to “3001”, which is the node ID of the own node A to thereby generate a catalog delivery message. Then, the node D refers to a routing table of the own node D and transmits the catalog delivery message to each nodes (nodes D1, D2, and D3) registered in each column of a table in level “3”, the number “3” being acquired by adding “1” to the ID mask “2, as shown in FIG. 11 (B).

In a manner similar thereto, although it is not shown, nodes E, F, A1, A2, A3, B1, B2, B3, C1, C2, and C3 which received the catalog delivery message in the second stage refer to routing tables of each nodes and generate a catalog delivery message, obtained by setting up an ID mask to be “2” and a target node ID to be the node ID of each of the nodes, with respect to each of nodes registered in each column (not shown) in a table of level 3 and transmit the catalog delivery message.

### (Fourth Stage)

Next, the node X converts the ID mask “2” in the header part of the catalog delivery message to “3” to thereby generate a catalog delivery message. Here, in a manner similar to the above, the target node ID is not changed. Then, the node X refers to the routing table shown in FIG. 6 and transmits the catalog delivery message to nodes registered in each column (nodes D, E, and F) in a table of level “4”, the number “4” being acquired by adding “1” to the ID mask “3”, as shown in a right upper area of a node ID space in FIG. 11 (A) and FIG. 11 (B).

Meanwhile, the node G which received the catalog delivery message from the node X in the third stage converts the ID mask “2” to “3” in the header part of the catalog delivery message and converts the target node ID “3102”, to “3123” which is the node ID of the own node A, to thereby generate a catalog delivery message. Then, the node G refers to a routing table of the own node G and transmits the catalog delivery message to a node G1 registered in each column of a table in level “4”, the number “4” being acquired by adding “1” to the ID mask “3”, as shown in FIG. 11 (B).

In a manner similar thereto, though it is not shown, each nodes which received the catalog delivery message in the third stage also refers to routing tables of each nodes and generates a catalog delivery message, obtained by setting up an ID mask to be “3” and a target node ID to be the node ID of each of the nodes with respect to each of the nodes registered in each column in a table of level 4 and transmits the catalog delivery message.

### (Final Stage)

Finally, the node X generates a catalogue delivery message obtained by converting the ID mask “3” in the header part of the catalog delivery message to “4”. Then, it is recognized from the target node ID and the ID mask that destination of the catalog delivery message is the own node X and finishes a transmission process.

Meanwhile, each nodes which received the catalog delivery message in the fourth stage also converts the ID mask “3” in the header part of the catalog delivery message to “4” to thereby generate a catalog delivery message. Thus, it is recognized from the target node ID and the ID mask that destination of the catalog delivery message is each of the own nodes and transmission process is finished.

As explained above, new content catalog information is delivered to all the nodes participating in the overlay network 9 using DHT multicast from the node X, being a catalog management node, and each node saves the content catalog information.

### [1.5 Presentation of Content Catalog Information by Time Division]

Meanwhile, as explained above, when new content catalog information delivered to all the nodes in a certain period is simultaneously enabled to present (enabled to be used) by users of all the nodes, many nodes acquire (download) new content data having new content catalog information and attribute information registered in the new content catalog information. Therefore, requests for index information of the new content data concentrate (i.e. content location inquiry messages including content ID of the new content data concentrate) on the root node, and requests for the new content data to further concentrate on the content retention node, whereby there will be concern that node load and network load are increased. This results in increment of waiting time which may cause dissatisfaction of a user against such the waiting time. Especially, immediately after the delivery of new content catalog information, the new content data registered therein is just thrown in. Accordingly, number of nodes acquiring and saving the new content data is small. Therefore, it is assumed that number of new content catalog information thus saved is not enough to satisfy the requests from many nodes.

Therefore, in the present embodiment, nodes participating in the overlay network 9 can be (further) divided into a plurality of groups according to (by) a predetermined grouping condition and each node saves condition information indicative of the grouping condition and presentation time information stipulating a presentation time when new content catalog information is to be presented to a user for example while making the presentation time differ with respect to each of the groups. Then, each node receives and saves the new content catalog information delivered. Thereafter, at a time of presentation time corresponding to a group to which the own node belongs, the new content catalog information is set up to be in a condition where presentation (disclosure) to a user is available. Thus, new content catalog information saved in nodes belonging to each of the groups is presented at different timings (in other words, shifting the presentation times with respect to each of the group) to users. Therefore, access to a root node or a content retention node can be distributed.

Here, factors to be the grouping condition are value of a predetermined digit in a node ID, installation area of a node, connection service provider of a node to the network 8, replay time (viewing/listening time) of content data in a node or number of replays (times of content is viewed/listened to), and energisation time of a node.

In a case where the value of a predetermined digit in a node ID is a factor of a grouping condition, it can be divided such that a node group having a lowest digit (or highest digit) of “1”, a node group having a lowest digit of “2”, . . . . Further, in a case where the node ID is a hexadecimal number, because a value of a predetermined digit is expressed by any one of 0 to F, it is possible to divide the nodes into sixteen (16) groups. Then, after all the nodes participating in the overlay network 9 receive new content catalog information (each node receives the new content catalog information almost simultaneously (though there is 0 to several seconds of time-lag)), all the nodes belonging to groups including node IDs, which have a lowest digit of for example “0” and “5”, are immediately set up to be in a presentation available condition. Subsequently, all the nodes belonging to groups including node IDs, which have a lowest digit of for example “1” and “6”, are set up to be in a presentation available condition after six hours (after a lapse of six hours from reception of the new content catalog information). Next, for example, all the nodes belonging to groups including node IDs, which have a lowest digit of for example “2” and “7”, are set to be in a presentation available condition after 12 hours (after a lapse of 12 hours from reception of the new content catalog information).

Further, in a case where an installation area of a node is set up to be the factor for grouping, it can be divided such that a node group with its installation area being Minato-ward, Tokyo, and a node group with its installation area being Shibuya-ward, Tokyo . . . . Such the installation areas can be judged from, for example, postal code or telephone number, set up in each of the nodes. Then, after all the nodes participating in the overlay network 9 receives the new content catalog information, for example, all the nodes belonging to a group of Shibuya-ward, Tokyo are immediately set up to be in a presentation available condition. Subsequently, for example, all the nodes belonging to a group of Minato-ward, Tokyo are set up to be in a presentation available condition after six hours (after a lapse of six hours from reception of the new content catalog information)

Further, when a connection service provider (for example, an internet connection service provider (hereinafter referred to as “ISP”)) for a node to the network 8 is set up to be a factor for grouping, for example, grouping can be carried out with reference to difference of autonomous system (AS) numbers. Here, AS is a cluster of networks, having one (common) operational policy and configuring the internet. The internet can be comprehended as a cluster of the ASs. For example, AS is classified for each network including each of ISPs and unique AS numbers, which are different from each other, is allocated from a range of, for example, 1 to 65535. Further, when each of the nodes is to acquire an AS number to which the own node belongs, it is possible to use methods of accessing to a database of WHOIS of the Internet Routing Registry (IRS) or Japan Network Information Center (JPNIC) (AS number is known from IP address), a method for a user of acquiring an AS number of a user's contract line from the ISP and inputting the number into the node in advance, and soon. Then, after all the nodes participating in the overlay network 9 receive new content catalog information, for example, all the nodes belonging to a group having an AS number of “2345” are immediately set up to be in a condition of enabling presentation of the new content catalog information. Subsequently, all the nodes belonging to a group having an AS number of “3456” are set up to be in a condition of enabling presentation of the new content catalog information after for example six hours elapses (after a lapse of six hours from reception of the new content catalog information).

Further, when a replay time (viewing/listening time) or a number of replays (number of times of viewing/listening content) of content data in a node is used as a factor for grouping, it is possible to divide into for example a group of nodes with its replay time being 30 hours or more (or those numbers of replay of 30 or more), a group of nodes with its replay time being 20 hours or more and less than 30 hours (or its number of replays of 20 or more and less than 30), . . . . Here, the replay time includes continuous replay time, average replay time, cumulative replay time, and the like. The continuous replay time designates, for example, continuous time during which content data are replayed without suspend (for example, latest continuous replay time), the average replay time designates an average time of the past several continuous replay time, and the cumulative replay time designates cumulative (total) replay time of content data in a predetermined period of time (for example, one month or since installation of the node to present). Further, the number of replays designates cumulative (total) number of times that how many times content data are replayed from the beginning to the end during a predetermined period of time (for example, one month or since installation of the node to the present). Longer the replay time or the number of replays the node has, higher the possibility of replaying content data long, wherein it can be said that a replica of the new content data is apt to be made. Here, the replay time and the number of replays respectively of the content data are measured in each node and saved therein.

Then, after all the nodes participating in the overlay network 9 receive new content catalog, all the nodes belonging to a group of a replay time of for example “30 hours or more” are immediately set up to be in a presentation enabled condition. Subsequently, all the nodes belonging to a group of a replay time of for example “20 or more and less than 30 hours” are set up to be in a presentation available condition after six hours elapses (after a lapse of six hours from reception of the new content catalog information). In such a manner, a group with its replay time longest or its number of replays most is, for example, given priority, and the nodes belonging to the group are first set up to be in a condition of enabling presentation. Thus, a node having high possibility of contributing to work as a content retention node which saves new content data (replica) so as to be supplied to other nodes can be preferentially set up to be in a condition of enabling presentation of new content catalog information.

Further, it is desirable that such the replay time or the number of replays is measured with respect to each genre of content data because preference of a user can be known. For example, when in a certain node a cumulative replay time of content data in a genre of “animation” is 30 hours during a predetermined past period of time, and a cumulative replay time of content data in a genre of “action” is 13 hours during a predetermined past period of time, it is known that this user of the node likes “animation”. In this case, a group having the longest cumulative replay time or the largest number of replays in a genre same as new content data with these attribute information registered in new content catalog information is given priority, and a node belonging to the group is first set up to be in a condition of enabling presentation of the new content catalog information.

Further, in a case where an energisation time in a node is used as a factor of a condition of grouping, it is possible to divide such that a group of nodes with its energisation time being “200 hours or more”, a group of nodes with its energisation time being “150 hours or more and less than 200 hours”, . . . . Here, the energisation time includes continuous energisation time, average energisatin time, cumulative energisation time, and the like. The continuous energisation time designates a continuous time while power is being turned on in a node at the moment (a time of receiving new content catalog information) and the average energisation time designates an average time of continuous energisation times in for example a past plurality of times (a period from power is turned on until turned off is counted as one energisation time), and the cumulative energisation time designates a cumulative time while power is being turned on during a past predetermined period of time (e.g. one month, or after installing node and until the moment). Further, because each of the nodes normally starts to participate in the overlay network 9 when power is turned on, the energisation time can also be regarded as a time while participating in the overlay network 9.

After all the nodes participating in the overlay network 9 receive new content catalog, all the nodes belonging to a group of, for example, “200 hours or more” energisation time are immediately set up to be in presentation available condition. Subsequently, all the nodes belonging to a group of “150 or more and less than 200 hours” energisation time are set up to be in a presentation available condition after six hours (after six hours elapses since reception of the new content catalog information). In such a manner, for example, a group having the longest energisation time is given priority, and nodes belonging to the group earliest become in a condition of enabling presentation of the new contents catalogue. Thus, it is possible to make a node, which has a high possibility of contributing as a content retention saving new content data (replica) so as to be served to other nodes, to be in a condition of enabling presentation.

Here, the replay time (viewing/listening time) may be indicated by audience rating, and the energisation time may be indicated by an energisation ratio. Audience rating (that is, ratio of content data being replayed by the node) is obtained by, for example, dividing an elapsed period of time of from installation of the node to this moment by a cumulative replay time of from installation of the node to this moment (elapsed time/cumulative replay time). Further, an energisation time is obtained by dividing an elapsed time of from installation of the node to this moment by a cumulative energisation time of from installation of the node to this moment.

Further, it is more effective to divide into groups by combining two or more of: values of predetermined digit on the node IDs; areas of installing the nodes; connection service providers for the nodes of connecting to the network 8; replay numbers of times (viewing/listening times) of content data in the nodes; energisation times of the nodes; and the like.

Meanwhile, numbers of groups divided in accordance with a condition for grouping is determined by number of nodes participating in the overlay network 9, processing ability of the system S, presentation interval of content catalog information (i.e. an interval between a presentation time when new content catalog information is set up to be in a presentation available condition in all the nodes belonging to one group and a presentation time when the new content catalog information is set up to be in a presentation available condition in nodes belonging to the next group). However, when a maximum value of the presentation interval is set up as one day (24 hours), it is adequate to set the number of around 10. In this case, a time lag of presenting from the first group to the last group is 10 days at maximum.

Further, in consideration of a time for creating a replica of new content data, it is preferable that the presentation interval is set up to be at least n times (e.g. 1.5 to 3 times) a total replay time (e.g. 2 to 3 hours) of starting to replay the content data and finishing to replay the contents data.

Further, because it is assumed that distribution of access frequency to a content retention node changes within a day. Especially, it is assumed that access frequency is lower in night than in day time. Therefore, it is possible to set up a presentation interval between 19:00 and 09:00 longer than a presentation interval between 09:00 and 19:00, to thereby prevent access from concentrating.

Further, it is conceived that a period for a user to audit (view and/or listen) varies within a day but is not longer than one day with respect to each day of week. Therefore, it is possible to make a presentation interval around one day (24 hours). For example, in case of content for children, because it is assumed that viewing/listening frequency is high between 17:00 and 20:00 irrespective of a day of a week, it is expected that many replicas are produced during this period. Therefore, there is a possibility of producing replicas enough for offering the new content data to nodes, belonging to a group in a next presentation order, in this short period of time (that is, replicas are saved in content retention nodes). However, because there is little possibility for the content of being viewed/listened to at night, production of a replica cannot be expected before the next day. Therefore, by setting up the maximum presentation interval as one day (24 hours), it is possible to deal with such variation of access frequency.

Furthermore, when the presentation interval is estimated request number of new content data requested by a plurality of nodes (e.g. a number of content location inquiry messages or a number of requesting new content data for content retention nodes), and set up on the basis of information indicative of the estimated request number, which varies in accordance with a lapse of time (e.g. an estimated popularity curve of new content data), presentation interval can be set up more efficiently.

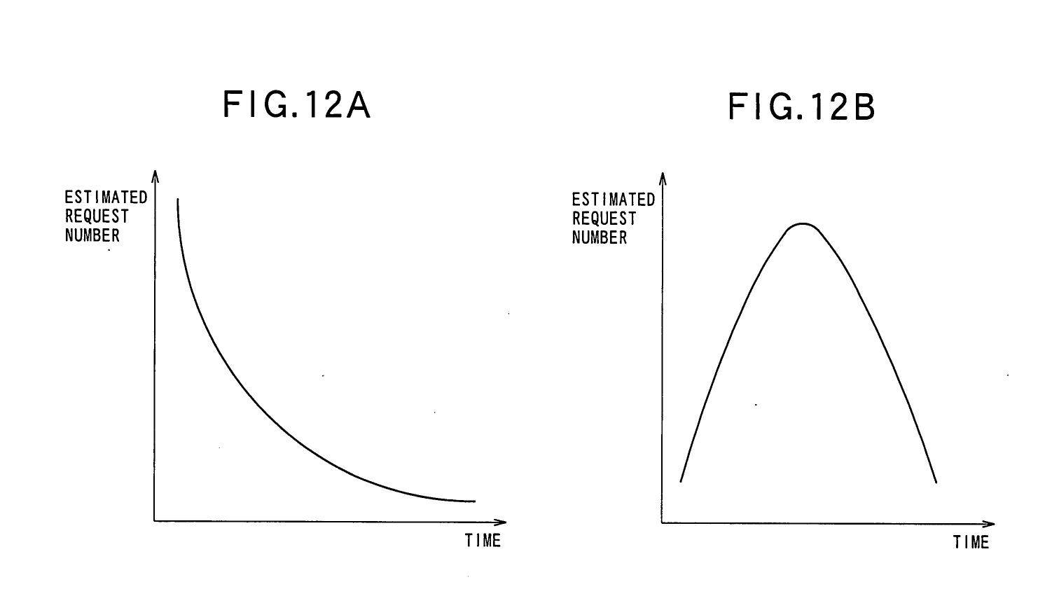

FIG. 12 is a view showing an example of an estimated popularity curve of new content data. Here, in both FIGS. 12(A) and (B), the axis of ordinate represents estimated request number of new content data, and the axis of abscissas represents time. The estimated request number is indicated by a curve which changes in accordance with a lapse of time. It is determined by for example analysis of a past example whether new content data having attribute information described in new content catalog information to be delivered at this time employs a curve pattern shown in FIG. 12 (A) or a curve pattern shown in FIG. 12 (B). For example, a curve pattern of the new content data is determined from a past request pattern of content data in a genre same as the genre of the new content data.

Then, for example, in case of new content data employing the curve pattern shown in FIG. 12 (A), because there is a tendency that requests are apt to immediately concentrate on after input, the presentation interval is set up long immediately after starting delivery of new content catalog information (for example, the presentation interval between the first group and the second group is set up as around two days) (to thereby suppress the request number and wait for production of replicas), and the presentation interval is set up to be gradually shortened (for example, the presentation period between the second group and the third group is set up as about 1.5 days, and further the presentation interval between the third group and the fourth group is set up as, for example, about one day).

On the other hand, in a case where new content data employing a curve pattern shown in FIG. 12 (B), because there is a tendency that requests gradually increase after input, a presentation interval immediately after starting to delivery new content catalog information is set up short (for example, a presentation interval between each of the groups is set up as about 2 hours) so that content catalog information reaches every node as soon as possible.

### 2. Node Configuration and the Like

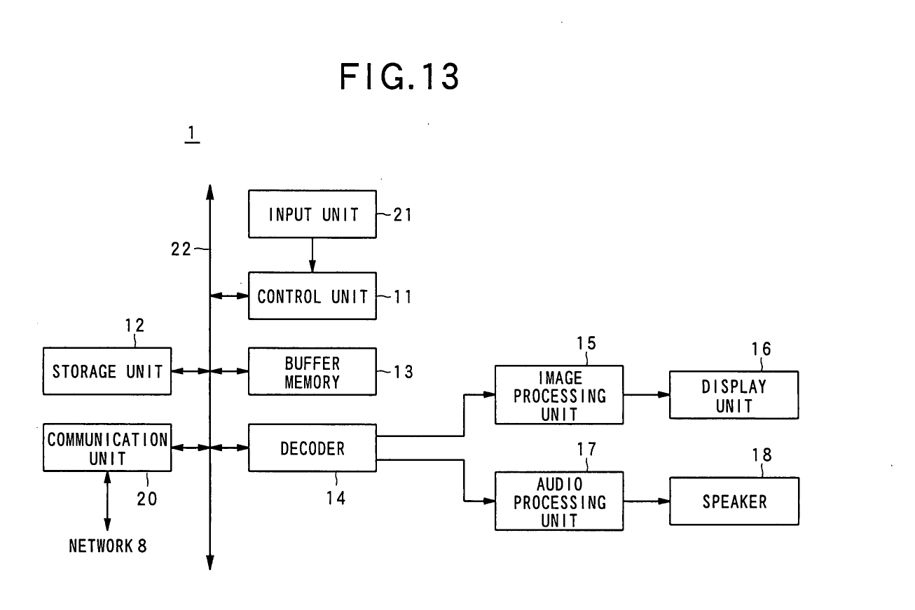

Next, with reference to FIG. 13, configuration and function of the nodes will be explained.

FIG. 13 is a view showing a schematic configuration example of the node.

Each of the node is configured by including, as shown in FIG. 13: a control unit 11 being a computer configured by a CPU having computing function, a RAM for work, and a ROM for storing various data and programs; a storage unit 12 configured by an HDD or the like for saving and retaining (storing) content data, content catalog information, routing table, various types of programs and the like; a buffer memory 13 for temporarily storing content data received; a decoder 14 for decoding (stretching data or decrypt) encoded video data (image information and audio data (voice information) included in the content data; an image processing unit 15 for providing a predetermined graphic process to the video data thus decoded or the like and outputting the data as video signal; a display unit 16 such as CRT or liquid crystal display for displaying image based on the video signal outputted from the image processing unit 15, or the like; an audio processing unit 17 for converting the decoded audio data in use of digital/analog (D/A) conversion into an analog audio signal, amplifying the converted signal by an amplifier and outputting the same; a speaker 18 for outputting the audio signal outputted from the audio processing unit 17 as acoustic wave; a communication unit 20 for carrying out communication control of information with respect to other node devices and servers via the network 8; and an input unit 21 for receiving and providing instruction signal from a user and providing the instruction signal corresponding to the instruction to the control unit 11 (for example, such as a key board, a mouse, or an operation panel), wherein the control unit 11, the storage unit 12, the buffer memory 13, the decoder 14, and the communication unit 20 are connected each other via a bus 22. Here, a personal computer, a set top box (STB), or a TV receiver are applicable as the nodes.

In such the configuration, when CPU in the control unit 11 carries out a program saved in the storage unit 12 or the like (including the node processing program according to the present invention), the control unit 11 of the node device 1 controls its entirety, carries out a process as any one of the above-mentioned user node, a relay node, a root node, a cache node, and a content retention node by participating in the content delivery system S, and especially functions as a new content catalog receiving means, a group judgment means, a presentation time judgment means, a content catalog presentation setting means, and the like according to the present invention as the user node.

Further, the control unit 11 of the node to be a catalog management node further reads out and carries out a program saved in the storage unit 12 or the like (including a delivery process program according to the present invention) and functions as the new content catalog delivery means or the like according to the present invention.

Further, the control unit 11 measures a replay time (or a number of replays) of content data in a case where the acquired content data are reproduced and outputted through the decoder 14, the image processing unit 15, the display unit 16, the audio processing unit 17, and the speaker 18, associates the time (or times) thus measured with genre of the content data to thereby save this. Here, average replay time and cumulative replay time are calculated on the basis of the replay time thus measured.

Further, the control unit 11 starts to measure an energisation time when the power is turned on, finishes the measurement when there is a command for turning off the power, and saves the energisation time thus measured. Here, the average energisation time and the cumulative energisation time are calculated on the basis of the energisation time thus measured.

Further, the storage unit 12 of each node saves a grouping condition table regulating the grouping condition and the presentation time of new content catalog information corresponding to each of the groups, and the control unit 11 judges a group, to which the own node belongs, by use of the grouping condition table and also judges whether or not there becomes (reaches) a presentation time corresponding to the group, to which the own node belongs. In a case where it is judged that the presentation time reaches, as mentioned above, the new content catalog information saved as above is set up to be in a condition of enabling presentation to a user. Here, the grouping condition table may be saved in the storage unit 12 in advance. However, it is preferable to deliver the grouping condition table after adding it to new content catalog information because the grouping condition or the presentation time can be appropriately set up in response to the number of nodes participating or load condition of the network 8 at the time of delivering the new content catalog information.

Here, following methods (i) to (iii) can be mentioned as “set up to be in a condition of enabling presentation”.

(i) Setup to cause attribute information of new content data, described in the new content catalog information, displayed on a display screen of the display unit 16 so as to be selectable (for example, popped-up display during a user watches the screen)
(ii) Set up to cause the new content data, described in the new content catalog information, searchable by a catalog as shown in FIG. 5
(iii) Set up to cause attribute information of new content data, described in new content catalog information, selectable by selecting a new content button (operation instruction of the input unit 21 by a user), provided on a menu screen on the display unit 16.

Here, in a case of the method (i), a user can immediately understand that new content catalog information is in a presentation enabled condition, but in cases of methods (ii) and (iii), a user cannot immediately understand that new content catalog information is in a condition that presentation is enabled. Therefore, in this case, it is effective to configure such that a mark indicative of new content catalog information is enabled to use is displayed on a display screen of the display unit 16 or voice telling that the new content catalog information is enabled to use is outputted from the speaker 18.

Further, in the storage unit 12 of each node, IP address and the like of a contact node is saved in advance, and further an AS number allocated when connected to the network 8 and a postal code (or a telephone number) inputted by a user are saved later.

Further, the node processing program and the delivery processing program may be downloaded from for example a predetermined server on the network 8 or for example may be recorded in a recording medium such as a CD-ROM and read out through a drive of the recording medium.

Although not shown in figure, the catalog management server is configured by a hardware of a server computer including: a control unit as computer, configured by a CPU having computing function, a RAM for work, a ROM for storing various data and programs and so on; a storage unit as a new content catalog saving means configured by an HD for saving (storing) content catalog information, various programs, and so on; a communication unit for controlling communication of information with respect to the other nodes through the network 8; and so on.

### 3. Operation Example of Content Delivery System

Next, operation of the content delivery system S will be explained.

### [3.1 Process by Catalog Management Node Delivering New Content Catalog Information]

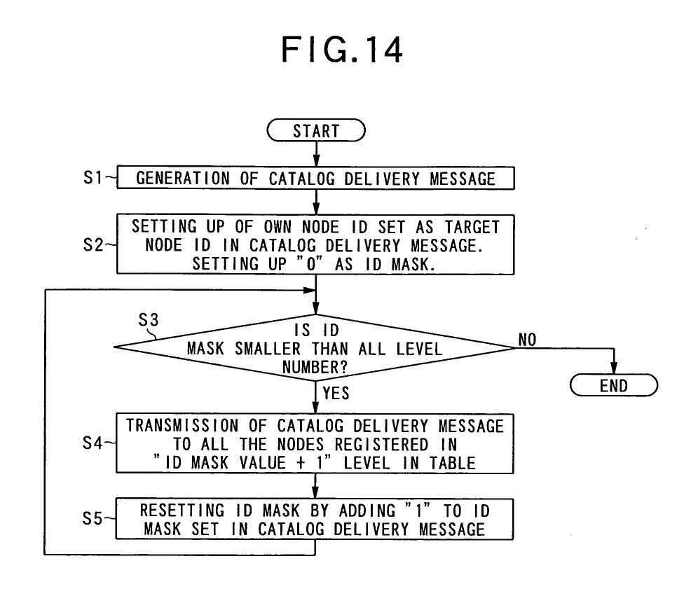

First, process by a catalog management node which delivers new content catalog information by DHT multicast will be described with reference to FIG. 14.

FIG. 14 is a flowchart showing new content catalog information delivery process carried out in a control unit 11 of the catalog managing node.

A process shown in FIG. 14 starts when information indicating new content data are thrown in a certain node (including attribute information of the new content data) is received by the node X, being a catalog management node, from for example a content input server (a server which permits throwing in of new content data in the content delivery system S and throws in the data to one or a plurality of nodes).

Here, into new content catalog information, attribute information of new content data may be described one by one or a plurality of new content data are inputted at the same time may be collected and attribute information thereof may be described. Further, a plurality of new content data thrown in at the same time may be collected by each genre and attribute information thereof may be described.

First, the control unit 11 of the node X generates a catalog delivery message including new content catalog information having attribute information of new content data, acquired from the content input server, described in it; a serial number of the new content catalog information (the serial number includes, for example, delivered year, month, day, and time); and the above-mentioned grouping condition table in the payload part (Step S1). The catalog delivery message thus generated is temporarily saved.

Next, the control unit 11 sets up a node ID of the own node X as for example “3102”, as a target node ID in the header part of the catalog delivery message thus generated, sets up “0” as an ID mask, and sets up the own IP address and the like as an IP address (Step S2).

Next, the control unit 11 judges whether or not a value of the ID mask thus set is smaller than all-level number of the own routing table (in the example of FIG. 6, “4”) (Step S3).

At this time, since “0” is set up as the ID mask, it is smaller than the all-level number of the routing table. Therefore, the control unit 11 judges the ID mask is smaller than the all-level number of the routing table (Step S3: YES), determines all of nodes registered in a level of “the set ID mask+1” in the routing table of the own node X (that is, because an area which the node X belongs to is further divided into a plurality of areas, one node belonging to each area thus further divided is determined), and transmits the catalog delivery message thus generated to the nodes thus determined (Step S4).

For example, in the example of FIG. 6, a catalog delivery message is transmitted to nodes A, B, and C that is registered in level 1, being a level of “ID mask “0”+1”.

Next, the control unit 11 adds “1” to the value of the ID mask thus set in the header part of the catalog delivery message to thereby re-set the ID mask (Step S5). Then the process returns to Step S3.

Subsequently, the control unit 11 repeats the processes of Steps S3 to S5 with regards to ID mask “1”, “2”, and “3” in a manner similar thereto. Thus, the catalog delivery message is transmitted to all the nodes, registered in the routing table of the own node X.

Meanwhile, when it is judged that the ID mask is not smaller than the all-level number of the routing table in Step S3, (in the example of FIG. 6, when a value of the ID mask is “4”) (Step S3: NO), the process is finished.

Thus, in a case where the new content catalog information is delivered by a catalog management node, the new content catalog information is delivered while being transferred sequentially to all the nodes participating in the overlay network 9 by DHT multicast. Therefore, it is possible to substantially reduce a load applied to a specific server such as the catalog management server.

### [3.2 Process by Node Receiving New Content Catalog Information]

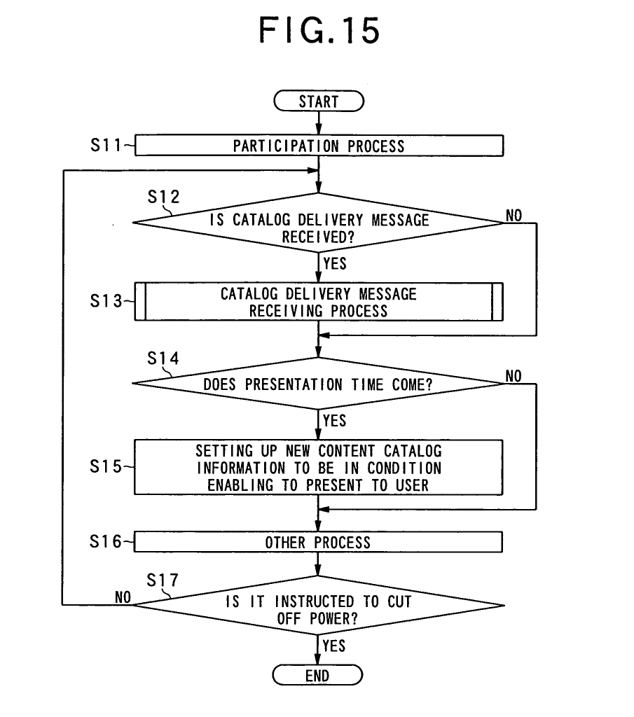

Next, a process by a node which receives the new content catalog information will be described with reference to FIG. 15.

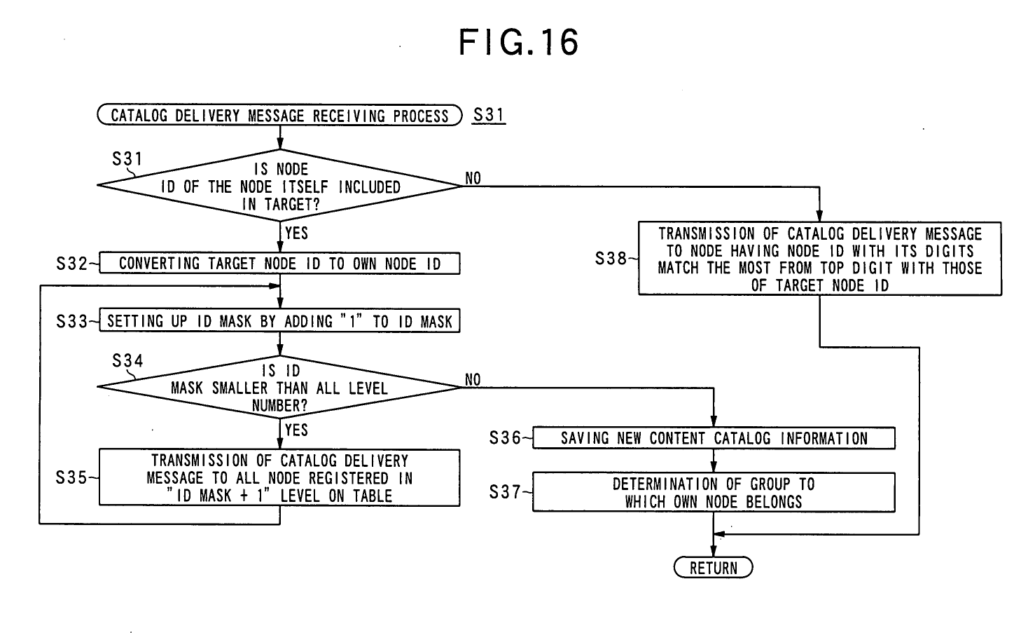

FIG. 15 is a flowchart showing a process in the control unit 11 of a node for receiving the new content catalog information. FIG. 16 is a flowchart showing details of a catalog delivery message receiving process shown in FIG. 15.

The process shown in FIG. 15 starts when power of for example the node A is turned on by a user. First, the control unit 11 carries out a participation process into the overlay network 9 (Step S11). In the participation process, as mentioned above, the node A is connected to a contact node (connected on the basis of IP address or the like of the contact node saved in the storage unit 12) to thereby request participation and a routing table of the own node A is made on the basis of for example a routing table, replied from the contact node or the like. Thus, the node A participates in the overlay network 9.

Next, the control unit 11 judges whether or not a catalog delivery message is received (Step S12). When the message is received (Step S12: YES), the process proceeds to Step S13. When the message is not received (Step S12: NO), the process proceeds to Step S14. Here, the catalog delivery message thus received is temporarily stored in the buffer memory 13.

In Step S13, catalog delivery message receiving process is performed. In the catalog delivery message receiving process, as shown in FIG. 16, the control unit 11 of the node A judges whether or not the node ID of the own node A is included in a target, specified by a target node ID, and an ID mask in the header part of the catalog delivery message thus received (Step S31).

Here, the target designates node IDs having common top digits corresponding to an ID mask value in a target node ID. For example, when an ID mask is “0”, all the node IDs are included in the target. When an ID mask is “2” and a target node ID is “3102”, node IDs being “31**” having top two digits of “31” are included in the target (** may be any value).

Because the ID mask in the header part of the catalog delivery message thus received by the node A is “0” and a valid digit number is not specified, the control unit 11 of the node A judges that the node ID “0132” of the own node A is included in the target (Step S31: YES) and changes and sets up the target node ID in the header part of the catalog delivery message to “0132” which is the node ID of the own node A (Step S32).

Next, the control unit 11 adds “1” to the ID mask value in the header part of the catalog delivery message and resets the ID mask (here, from “0” to “1” (by changing an ID mask indicating one level to an ID mask indicating the next level)) (Step S33).

Next, the control unit 11 judges whether or not the ID mask value thus reset is smaller than the all-level number of the routing table of the own node A (Step S34).

At this time, because “1” is set up in the ID mask, it is smaller than the all-level number of the routing table. Therefore, the control unit 11 judges that the ID mask is smaller than the routing table of the own node A (Step S34: YES), determines all the nodes registered in a level of “the re-set ID mask+1” in the routing table of the own node A (namely, because an area which the node A belongs to is further divided into a plurality of areas, there is determined one node belonging to each area further divided), and transmits the catalog delivery message thus generated to the node thus determined (Step S35). Then the process goes back to Step S33.

For example, the catalog delivery message is transmitted to nodes A1, A2, and A3, registered in level 2 which is “ID mask “1”+1”.

Subsequently, the control unit 11 repeats the same process in Steps S34 and S35 for the ID masks “2” and “3”. Thus, the catalog delivery message is transmitted to all the nodes registered in the own routing table.

Meanwhile, in a case where the control unit 11 judges that the node ID is not included in the target specified by the target node ID and ID mask in the header part of the catalog delivery message thus received in the Step S31 (Step S31: NO), and the catalog delivery message thus received is transmitted to a node having a node ID with its top digits matching most the target node ID in the routing table (transmission of a message using normal DHT) (Step S38). Then the process is finished. For example, when the ID mask is “2” and the target node ID is “3102”, the node ID of the node A “0132” is judged not to be included in the target “31**”.

On the other hand, when the control unit 11 judges that the ID mask value is not smaller than the all-level number of the routing table of the own node A in the Step S34 (Step S34: NO), new content catalog information included in the catalog delivery message stored in the buffer memory 13 is saved and retained in the storage unit 12 with a serial number of the new content catalog information (Step S36).

Then, the control unit 11 takes a grouping condition table included in the catalog delivery message, refers to the grouping condition table, carries out a group judgment process on the basis of replay time, measured in advance as mentioned above and saved in the storage unit 12 (a process of judging a group to which the own node A belongs out of groups divided in accordance with the grouping condition (e.g. replay time of the content data, energisation time of the node, or a combination of such factors)), and determines a group to which the node A belongs (Step S37). Subsequently, a presentation time of new content catalog information, corresponding to the group thus determined, is set up (for example, six hours), and counting is started. Then the process returns to a process shown in FIG. 15.

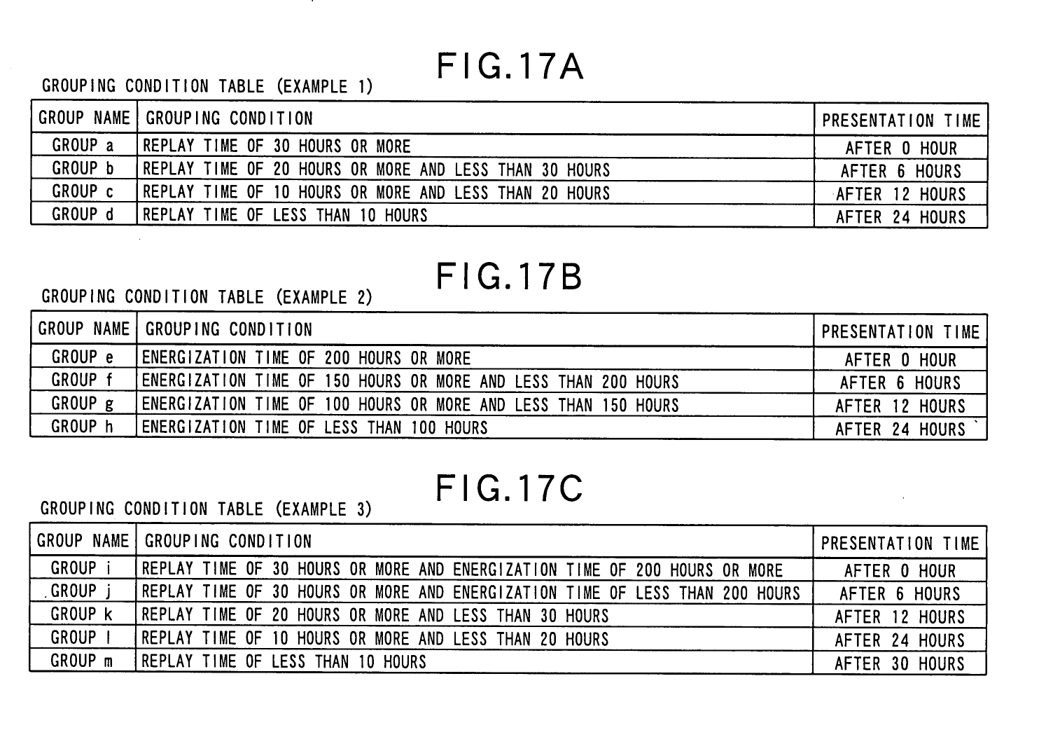

FIGS. 17 (A) to (C) are views showing an example of content of a grouping condition table.

In the grouping condition table shown in FIG. 17 (A), a replay time of content data (for example, cumulative replay time) is set up to be a factor of grouping condition and nodes are divided into a group a with its “replay time of 30 hours or more”, a group b including content data with its “replay time of 20 hours or more and less than 30 hours”, a group c including content data with its “replay time being 10 hours or more and less than 20 hours”, and a group d including content data with its “replay time being less than 10 hours”. Then, the presentation time of new content catalog information is set up as follows: “after 0 hour” (i.e. immediately) for the group a, “after six hours” for the group b, “after 12 hours” for the group c, and “after 24 hours” (i.e. earliest presentation is set up for the group a having the longest replay time) for the group d. For example, when a replay time (for example, cumulative replay time) of content data in the node A is 15 hours, the node A is judged to be included in the group b having nodes with its replay time being “20 hours or more and less than 30 hours”.

Further, in the grouping condition table shown in FIG. 17 (B), energisation time is set up to be a factor for grouping and nodes are divided into a group e with its “energisation time being 200 hours or more”, a group f with its “energisation time being 150 hours or more and less than 200 hours”, a group g with its “energisation time being 100 hours or more and less than 150 hours”, and a group h with its “energisation time being less than 100 hours”. Then, the presentation time of new content catalog information is set up as follows: “after 0 hour” (i.e. immediately) for the group e, “after six hours” for the group f, “after 12 hours” for the group g, and “after 24 hours” (i.e. earliest presentation is set up for the group e having the longest energisation time) for the group h. For example, when the energisation time (e.g. cumulative energisation time) of node A is 120 hours, the node A is judged to be included in the group g having nodes with its “energisation time being 100 hours or more and less than 150 hours”.

Further, in the grouping condition table shown in FIG. 17 (C), a combination of the replay time and the energisation time is set up to be a factor for grouping and nodes are divided into a group i with its “replay time being 30 hours or more and energisation time being 200 hours or more”, a group j with its “replay time being 30 hours or more and energisation time being less than 200 hours”, . . . or the like. Then, the presentation time of new content catalog information is set up as follows: “after 0 hour” (i.e. immediately) for the group i, “after six hours” for the group j, . . . and the like. As such, by giving the highest priority to the group i with its “replay time being 30 hours or more and energisation time being 200 hours or more”, it becomes possible to present with priority the new content catalog information to a user having a high possibility of viewing/listening to the new content data. Therefore, it becomes possible to increase a probability of increasing replicas of the new content data on the overlay network 9 (i.e. increasing content retention nodes saving replicas of the new content data). Further, it becomes possible to present with priority the new content catalog information to a node having long energisation time and a low possibility of withdrawing from the overlay network 9. Therefore, it becomes possible to raise a probability for other nodes of acquiring the new content data (in response to request for acquiring the new content data). Since the replicas are efficiently saved first in such a manner, accesses to the new content data are distributed from the next time.

Here, in the grouping condition table shown in FIG. 17 (C), condition for combination may be changed such as “30 hours or more replay time and 150 hours or more and less than 200 hours of energisation time” for the group j, “30 hours or more replay time and 100 hours or more and less than 150 hours of energisation time” for the group k, “20 hours or more and less than 30 hours of replay time and 150 hours or more and 200 hours or more of energisation time” for the group m.

Further, it is effective to add information indicative of a genre (e.g. animation) of the new content data with its attribute information described in the new content catalog information, included in the catalog delivery message in the grouping condition table, included in the catalog delivery message, and the control unit 11 judges a group, to which the own node belongs to, out of groups divided into a plurality of numbers in response to a replay time corresponding to a genre same as the new content data on the basis of the replay time or the like, which is measured as mentioned above, correlated with each genre and saved in the storage unit 12, because such a configuration enables to present with priority the new content catalog information to a user having a high possibility of viewing/listening to the new content data.

Further, in the examples shown in FIG. 17 (A) to (C), examples by which presentation time of the new content catalog information is divided step by step. However, the present invention is not limited thereto, and when it is configured that each node calculates presentation time of the new content catalog information on the basis of a predetermined conditional expression, it is possible to stipulate more detailed presentation time according to, for example, replay time, and number of replays. For example, when presentation time is denoted by T (time), number of replays of content data is denoted by S (number of times), and the conditional expression is “T=72-3N” (where when T is a negative value, set up to be “0”), presentation time T of nodes belonging to a group having 24 or more number of replays S is after “0” hour (that is, immediately), presentation time T of nodes belonging to a group having 18 number of replays S is after “24” hours (one day), and presentation time T of nodes belonging to a group having 0 replayed time S is after “72” hour (three days).

Now going back to process shown in FIG. 15, in Step S14, it is judged whether or not the presentation time for the new content catalog information corresponding to the determined group comes (that is, has counting which started by determination of groups in the Step S37 finished or not). When the presentation time for the new content catalog information does not come yet (Step S14: NO), the process goes to Step S16. When presentation time for the new content catalog comes (Step S14: YES), the control unit 11 sets the new content catalog information saved in the Step S36 to be in a condition where presentation to a user is enabled (Step S15), and for example attribute information of the new content data described in the new content catalog information is displayed on the display unit 16 in a selectable manner.

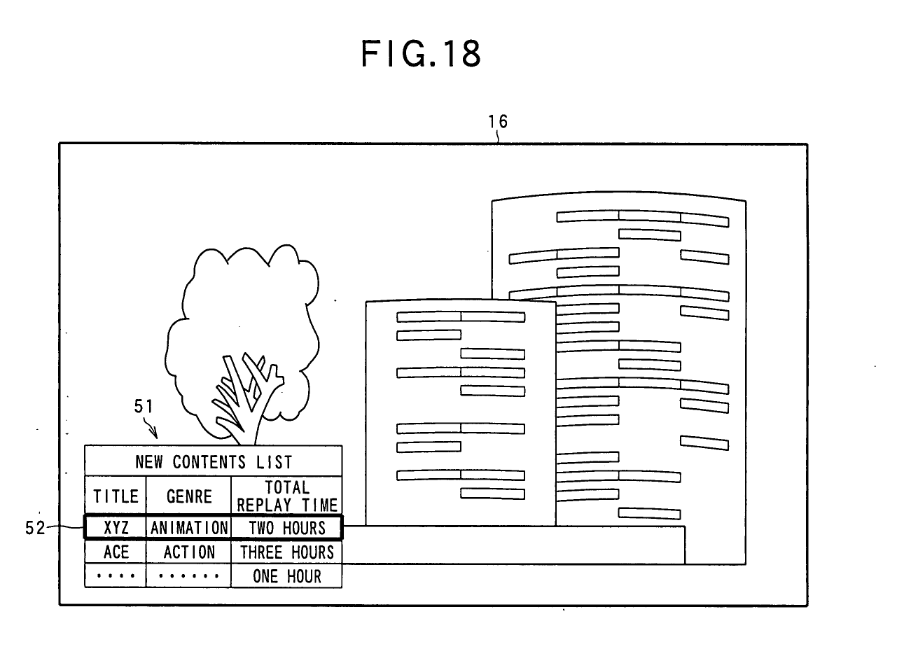

FIG. 18 is a view showing an example of a case where a list of new content data described in new content catalog information is pop-up displayed on a display screen of the display unit 16. In a list 51 shown in FIG. 18, attribute information such as title, genre, and total replay time of the new content data is indicated. When a user operates the input unit 21 to select and execute a title of desired new content data by a cursor 52, as mentioned above, a content location inquiry message including a content ID of the new content data is transmitted to the root node.

In Step S16, other process such as process corresponding to an instruction through the input unit 21 by a user or process corresponding to a message received from another node (e.g. a content location inquiry message or the like) is performed and the process proceeds to Step S17.

In Step S17, it is judged whether or not a power off instruction from a user receives and when power off instruction is not received yet (Step S17: NO), the process returns to Step S12 to thereby continue the process. When the power off instruction is received (Step S17: YES), the process is finished.

As explained above, according to the present embodiment, new content catalog information is delivered to all the nodes and the new content catalog information is presented to a user of a node belonging to each group divided according to a grouping condition at different times (in a shifting the timing) for each group. Therefore, device (a node or a server) load and network load caused by concentration of accesses can be suppressed as much as possible. Further, each node judges a group to which the node belongs and presentation time of the group so that new content catalog information can be autonomously presented to a user.

Further, it is possible to reduce waiting time for a user without increasing equipment expenses for reinforcement of the system for initial storage of new content data or the like.

Further, a group having a high possibility of using new content catalog information (that is, having a high possibility of requesting new content data), for example, a group having a longest replay time (or number of replays is the most), a group having a longest energisation time or the like is prioritized for presentation of the new content catalog information to a user of a node, belonging to the group (that is, presented to a node possibly having high contribution as a content retention node storing a replica enabled to be acquired by other nodes). Therefore, it is possible to distribute and save enough number of replicas of new content data at an early stage without increasing system load.

### 4. Modified Embodiment

In the above-mentioned embodiment, it is judged whether or not presentation time corresponding to a group to which a node belongs comes with respect to the new content catalog information received and saved by each node. When it is judged that the presentation time comes, the new content catalog information is set up to be in a condition where presentation to a user is enabled. However, in the following modified embodiment, a catalog management node or a catalog management server transmits a presentation instruction message (presentation instruction information) to cause the new content catalog information to be presented to a user at different times for each group.

Configuration and function of a node in this modified embodiment is same as the above-mentioned embodiment. Further, the control unit 11 of a node to be a catalog management node in this modified embodiment further functions as a presentation instruction information transmission means, a request number information acquisition means, a node number information acquisition means, and the like of the present invention.

Further, in this modified embodiment, new content catalog information is delivered by DHT multicast (by process shown in FIG. 14) by, for example, a catalog management node.

### [4.1 Process 1 by Catalog Management Node Delivering Presentation Instruction Message]

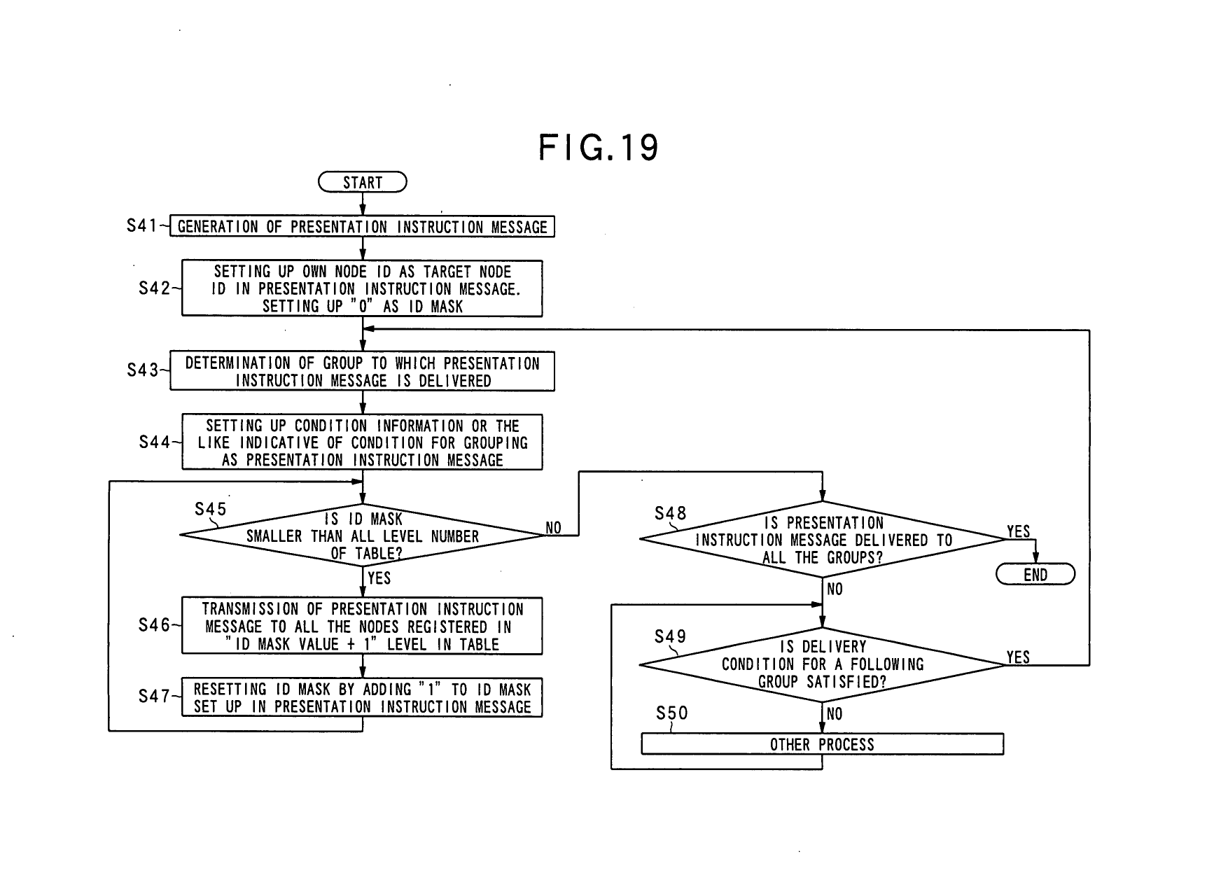

First, process by a catalog management node which delivers a presentation instruction message will be explained with reference to FIG. 19.

FIG. 19 is a flowchart showing presentation instruction message delivery process in the control unit 11 of the catalog managing node.

In this case, a catalog management node saves the above-mentioned grouping condition table.

Process shown in FIG. 19 starts in, for example, the node X being a catalog management node immediately after, for example, delivery of the above-mentioned new content catalog information.

First, the control unit 11 of the node X generates a presentation instruction message (Step S41) and temporarily saves the message.

Next, the control unit 11 sets up the node ID “3102” of the own node X as a target node ID in the header part of the presentation instruction message thus generated, sets “0” as an ID mask, and sets up an IP address or the like of the own node X as an IP address (Step S42).

Next, the control unit 11 refers to the grouping condition table saved in, for example, the storage unit 12 and determines (selects) a group to be a delivery target (Step S43). For example, when a grouping condition table shown in FIG. 17 (A) is used, delivery order of the presentation instruction message is as follows: group a is the first, group b is the second, group c is the third, and group d is the fourth. In this case, for example, the group a having a first delivery order and a longest replay time is selected first (in the first loop) (in the following loops, groups having longer replay time are sequentially selected (by the delivery order of second to third to fourth)).

Here, to a group which has been selected once, for example, a flag (“1”) is set up to prevent the group from being selected again.

Next, the control unit 11 sets up, in the payload part in the presentation instruction message, a serial number for specifying condition information indicating grouping condition corresponding to the group thus determined (for example, 30 hours or more replay time, or 30 hours or more replay time and 200 hours or more energisation time) and specifying new content catalog information to be a presentation target to a user (Step S44).

Here, it is possible to preferentially present new content catalog information to a user having high possibility of wanting and using the new content catalog when the grouping condition table, for example, one shown in FIG. 17 (A), is used, condition information indicating grouping condition such as “replay time of content data of which genre (for example, the same genre as new content data having attribute information of animation registered in new content catalog information to be a presentation target) being 30 hours or more” is set up in the payload part of the presentation instruction message, and for example when the grouping condition table shown in FIG. 17 (C) is used, condition information indicative of the grouping condition such as “replay time of content data in a genre of animation is 30 hours or more and energisation time is 200 hours or more” is set up in the payload part of the presentation instruction message

Next, the control unit 11 judges whether or not the ID mask (value) thus set is smaller than the all-level number of the routing table of the own node X (in the example of FIG. 6, “4”) (Step S45). When the ID mask is set up to be “0”, since it is smaller than the all-level number of the routing table, the control unit 11 judges that it is smaller than the all-level number of the routing table (Step S45: YES), determines all the nodes registered in a level of “the set ID mask+1” in the routing table of the own node X, transmits the presentation instruction message to the nodes thus determined (Step S46), and starts counting. Here, the counting continues until the presentation instruction message reaches nodes belonging to all the groups. That is, counting proceeds from start of counting to 6 hours to 12 hours, and so on.

Next, the control unit 11 adds “1” to the ID mask set in the header part of the presentation instruction message to reset the ID mask (Step S47) and the process returns to Step S45.

Subsequently, the control unit 11 repeats process of Steps S45 to S47 in the manner similar to ID masks “1”, “2”, and “3”. Thus, the presentation instruction message is transmitted to all the nodes registered on the routing table of the own node X.

On the other hand, when it is judged that the ID mask is not smaller than the all-level number of the routing table of the own node X (Step S45: NO), the process proceeds to Step S48.

In Step S48, the control unit 11 judges whether or not a presentation instruction message is delivered to all the groups stipulated by the grouping condition table. When the presentation instruction message is not delivered to all the groups (for example, when none of four groups in the grouping condition table shown in FIG. 17 (A) is selected in the above-mentioned Step S43) (Step S48: NO), it is judged whether or not delivery condition for the next group is satisfied (for example, counting started after transmission of the presentation instruction message in Step S46 has come to the presentation time corresponding to a next group (for example, whether or not six hours which is the presentation time of the group b shown in FIG. 17 (A) elapses)) (Step S49). When a delivery condition for the next group is not satisfied (for example, the presentation time does not reach yet) (Step S49: NO), the control unit 11 carries out other process (Step S50) and returns to Step S49. The other process in Step S50 includes, for example, process corresponding to various messages received from other nodes or the like.

On the other hand, when the delivery condition for the next group is satisfied (for example, the presentation time has come) (Step S49: YES), the process returns to Step S43, the next group to be a delivery target of presentation instruction message is selected (for example, a group having next longest replay time), and process in Step S44 and following Steps which are similar to the above is carried out.

Then, in the above-mentioned Step S48, in a case where it is judged that the presentation instruction message is delivered to all the groups (Step S48: YES), the process finishes.

Here, in the above-mentioned Step S43, groups are determined using a replay time of content data as a factor of the grouping condition. However, other than the above, number of replaying content data, value of a predetermined digit of a node ID (for example, the last digit), installation area of a node, connection service provider for a node to the network 8, energisation time of a node, a combination of any of the above or the like may be a factor for the grouping condition in order to determine a node belonging to a group to be a delivery target.

Further, in the above-mentioned Step S49, the control unit 11 of the catalog management node may acquire request number information indicative of a number of requests for acquiring new content data (for example, content location inquiry message) from nodes after delivery of the presentation instruction message to the nodes belonging to one group from, for example, a root node of the new content data or a cache node (acquire with a predetermined interval (for example, one hour interval)) and judge whether or not number of requests indicated by the request number information has exceeded a predetermined standard number (for example, a number which ensures sufficient replicas). When it is judged that the standard number has been exceeded, it is judged that the delivery condition is satisfied and the process may return to Step S43 to select a next group to be a delivery target of the presentation instruction message. According to this configuration, because it is expected that request number of popular new content data exceeds the standard number relatively quickly, presentation instruction message can be quickly delivered to a node belonging to the next group and content catalog information already saved in a node can be presented to a user.

Here, judgment that whether or not a number of request for acquiring new content data (for example, content location inquiry message) exceeds a predetermined standard number may be performed by a root node, a cache node, a license server for managing a root node or a cache node, or the like. When the number has exceeded the standard number, information indicating that the number has exceeded the standard number may be transmitted to a catalog management node and the catalog management node may judge that the delivery condition in the above-mentioned Step S49 is satisfied when the information indicating that the number has exceeded the standard number is received.

Further, it is more effective to judged whether or not a number of requests for acquiring the new content data exceeds a predetermined standard number, and whether or not presentation time for a next group comes and when either of the above is satisfied, it is judged that the delivery condition is satisfied in the above-mentioned Step S49. In other words, there is an advantage that because it is expected that request number of popular new content data relatively quickly exceeds a standard number, presentation instruction message can be swiftly delivered to a node belonging to a next group when the request number exceeds the standard number without waiting until the presentation time comes, while it is expected that request number of unpopular new content data does not exceed a standard number indefinitely, presentation instruction message can be swiftly delivered to a node belonging to a next group before the request number reaches the standard number when the presentation time comes.

Further, when the control unit 11 of a catalog management node can acquire information indicative of a number of nodes belonging to each group (number of nodes participating in the overlay network 9), when a request number indicated in the request number information reaches a predetermined ratio (for example, 10%) of number of nodes belonging to a group, to which presentation instruction message has been previously transmitted, a next group may be determined and the presentation instruction message may be transmitted to a node belonging to the group. Further, in this case, the control unit 11 of the catalog management node may determine a next group and transmit the presentation instruction message to a node belonging to the group when a request number indicated by request number information reaches a predetermined ratio of a number of nodes belonging to a group to which the presentation instruction message has been previously transmitted, and a number of request per a unit time indicated by the request number information has decreased (that is, the requests are decreasing). With such a configuration, it is possible to present new catalog information to many users of nodes more swiftly while suppressing node load and network load.

Here, a number of nodes belonging to each group is calculated by a server (for example, a license server) collecting information necessary for grouping such as replay time of content data (or number of replays), installation area of a node, connection service provider of a node to the network 8, energisation time of a node, and the like from, for example, all the nodes participating in the overlay network 9 and is provided to the catalog management node.

### [4.2 Process by Node Receiving Presentation Instruction Message]

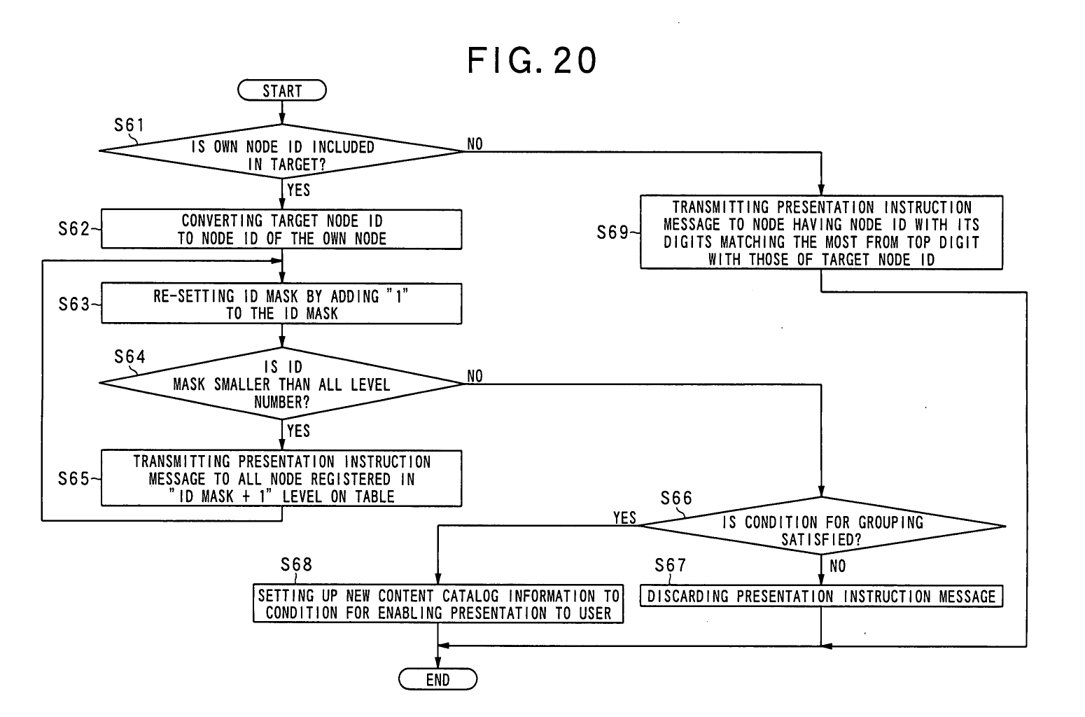

Next, process by a node which receives the presentation instruction message will be explained with reference to FIG. 20.

FIG. 20 is a flowchart showing process in the control unit 11 of a node for receiving the presentation instruction message.

Next, each node which received the presentation instruction message transmitted as above temporarily stores the presentation instruction message and starts process shown in FIG. 20. Here, an explanation will be given to the node A as an example.

Here, the processes of Steps S61 to S64 and S69 shown in FIG. 20 are similar to those of Steps S31 to 34 and S38 shown in FIG. 16 (difference is in catalog delivery message and presentation instruction message) and therefore, explanation thereof is omitted.

When the control unit 11 judges that the ID mask is smaller than the all-level number of the routing table (Step S64: YES), the control unit 11 determines all the nodes registered in a level of “the re-set ID mask+1” on the routing table of the own node A, transmits (transfers) a presentation instruction message with its target node ID changed and set up and ID mask is re-set to the nodes thus determined (Step S65), and the process returns to Step S63.

Subsequently, the control unit 11 repeats the process in Steps S64 and S65 with regards to ID mask “2” and “3”. Thus, the presentation instruction message is transmitted to all the nodes registered on the routing table of the own node A.

On the other hand, in the above Step S64, when the control unit 11 judges that the ID mask value is not smaller than the all-level number of the routing table of the own node A (Step S64: NO), the control unit 11 extracts a serial number for specifying condition information indicating grouping condition included in the payload part of the presentation instruction message thus temporarily stored and new content catalog information and judges whether or not the grouping condition indicated in the condition information thus extracted is satisfied (Step S66).

For example, when “30 hours or more replay time” is indicated as the grouping condition, the control unit 11 judges whether nor not replay time (e.g. cumulative replay time) saved in the storage unit 12 is 30 hours or more (when a genre is not specified in the grouping condition, it is judged whether or not cumulative replay time corresponding to each genre is 30 hours or more and the same is applied for number of replays). When the cumulative replay time is not 30 hours or more, the control unit 11 judges that the grouping condition is not satisfied (Step S66: NO), discards (deletes) the temporarily stored presentation instruction message (Step S67), and finishes the process.

Further, for example, when a genre is specified as a grouping condition of the condition information like “replay time of content data having a genre of animation is 30 hours or more”, the control unit 11 judges whether or not cumulative replay time corresponding to a genre of “animation” is 30 hours or more (the same is applied for the number of replays) and when the cumulative replay time is not 30 hours or more, the control unit 11 judges that the grouping condition is not satisfied (similar in energisation time and other factors of the grouping condition).

On the other hand, when the control unit 11 judges that the grouping condition is satisfied (that is, destination of the presentation instruction message is a group to which the own node A belongs) (Step S66: YES), the control unit 11 sets up the new content catalog information corresponding to the serial number thus extracted to a condition where presentation to a user is enabled in a manner similar to Step S15 shown in FIG. 15 (Step S68), and for example displays attribute information of new content data described in the new content catalog information on the display unit 16 in a selectable manner.

Thus, the presentation instruction message is substantially delivered only to a node satisfying the grouping condition and new content catalog information is enabled to be used by a user (e.g. a content ID of new content data in new content catalog information is acquired and a content location inquiry message including the content ID is transmitted to a root node, as mentioned above).

Because the catalog management node transmits a presentation instruction of already-delivered new content catalog to each node at different times and each of the nodes sets the new content catalog information to be in a condition where presentation to a user is enabled when the presentation instruction is received, it is possible to suppress device load and network load caused by concentration of accesses as much as possible, to reduce waiting time for a user, and at the same time, to avoid judging whether or not presentation time of new content catalog information has come on the side of each node.

### [4.3 Process 2 of Catalog Management Node Transmitting Presentation Instruction Message]

Here, when the top digit value of a node ID is set up to be a factor of the grouping condition, it is possible to deliver a presentation instruction message to a node belonging to a group to be a delivery target by use of DHT multicast.

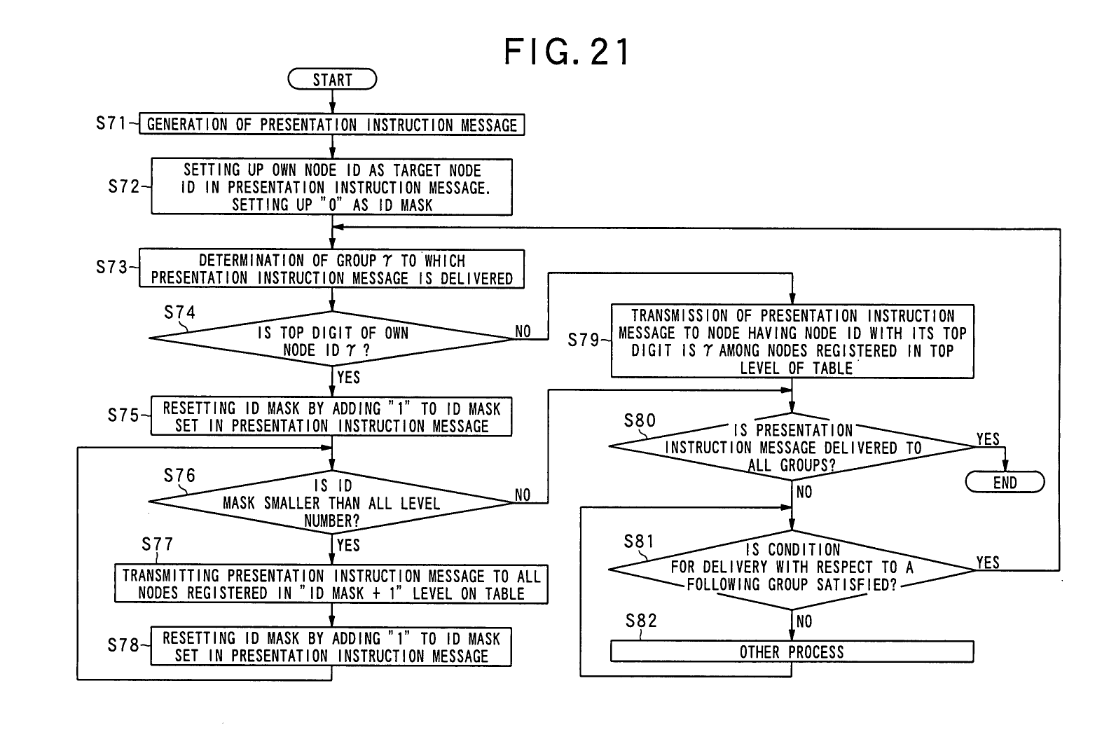

Process by the catalog management node in this case will be explained with reference to FIG. 21.

In this case, the catalog management node also saves the above-mentioned grouping condition table.

FIG. 21 is a flowchart showing the presentation instruction message in the control unit 11 of the catalog managing node when a value of top character of a node ID is set to be a factor for grouping condition.

Here, process in Steps S71 and S72 shown in FIG. 21 is similar to that of Steps S41 and S42 in FIG. 19. Therefore, explanation thereof is omitted.

Then, in Step S73, the control unit 11 of the catalog management node determines a group γ to be a delivery target of the presentation instruction message thus generated. Here, when the node ID is a hexadecimal number, γ is any one of values 0 to F. However, for easy of explanation, explanation will be done on a premise that the node ID is four-digit quaternary number.

Next, the control unit 11 judges whether or not the top digit of the node ID of the own node (for example, provided that it is “3102”) is γ (Step S74). In a case where the top digit is γ (Step S74: YES), “1” is added to the ID mask set in the header part of the presentation instruction message and the ID mask is reset (Step S75).

Next, the control unit 11 judges whether or not the ID mask is smaller than the all-level number of the routing table of the own node (in the example of FIG. 6, “4”) (Step S76). When the ID mask is smaller than the all-level number of the routing table, the control unit 11 determines all the nodes registered in a level of “the ID mask+1” on the routing table of the own node (in this case, ID mask “1”+“1”=“2”), transmits the presentation instruction message thus generated to the node thus determined (Step S77), and starts counting.

In the example of FIG. 6, the presentation instruction message is transmitted to nodes D, E, and F registered in level 2, which is “ID mask “1”+1”. However, the presentation instruction message is not delivered to nodes A, B, and C, registered in level 1.

Next, the control unit 11 adds “1” to the ID mask set up in the header part of the presentation instruction message and the ID mask is reset (Step S78), and the process returns to Step S76.

Subsequently, the control unit 11 repeats the processes of Steps S76 to 78 with regard to ID masks “2” and “3” in a manner similar thereto. Thus, the presentation instruction message is transmitted to all the nodes in levels 2 to 4 registered in the routing table of the own node. Then, by each node which has received the presentation instruction message thus transmitted, process in Steps S61 to 65 shown in FIG. 20 is performed. As a result, the presentation instruction message is delivered to nodes belonging to, for example, a group γ (=3) (for example, nodes having node IDs in a range between “3000” and “3333” in right upper portion of FIG. 8 (A)). In this case, process in Steps S66 and S68 is not performed and each of the nodes which have received the presentation instruction message sets new content catalog information corresponding to a serial number included in the presentation instruction message to a condition where presentation to a user is enabled in a manner similar to Step S15 shown in FIG. 15.

On the other hand, when it is judged that the ID mask is not smaller than the all-level number of the routing table in the above-mentioned Step S76 (in the example of FIG. 6, when the ID mask is “4”) (Step S76: NO), the process proceeds to Step S80.

Then, the control unit 11 judges whether or not the presentation instruction message is delivered to all the groups (γ=0 to 3). When the presentation instruction message is not delivered to all the groups (Step S80: NO), in a similar manner to the above-mentioned Step S49, it is judged whether or not delivery condition for the next group is satisfied (for example, whether or not counting started after transmission of the presentation instruction message in Step S77 reaches a presentation time corresponding to the next group) (Step S81).

When the delivery condition for the next group is not satisfied (Step S81: NO), the control unit 11 performs other process in a manner similar to the above-mentioned Step S50, and the process returns to Step S81.

On the other hand, when the delivery condition for the next group is satisfied (Step S81: YES), the process returns to Step S73 and a next group γ (for example, 0) to be a delivery target of the presentation instruction message is selected.

Here, in the above-mentioned Step S81, in a manner similar to the above-mentioned Step S49, the control unit 11 of the catalog management node may acquire request number information indicating number of requests by nodes belonging to one group for acquiring new content data after delivery of the presentation instruction message to the nodes and judge that the delivery condition is satisfied when the number of requests indicated by the request number information exceeds the previously set standard number. Further, in the above-mentioned Step S81, the control unit 11 of the catalog management node may judge whether or not the number of request for acquiring the new content data exceeds the previously set standard number, also judge whether or not presentation time for a next group has come and when either of the above is satisfied, may judge that the delivery condition is satisfied.

Further, in the above-mentioned Step S81, it may be possible to construct the control unit 11 of the catalog management node judges that the delivery condition is satisfied in a case where the number of requests indicated in the request number information reaches a predetermined ratio (e.g. 10%) of the number of nodes belonging to a group, to which the presentation instruction message has been previously delivered. Further, in this case, when the number of requests indicated by the request number information reaches the predetermined ratio of the number of nodes belonging to the group to which the presentation instruction message has been previously delivered, and a number of request per unit time indicated by the request number information has decreased (that is, the requests are decreasing), the control unit 11 may judge that the delivery condition is satisfied.

Then, in this case, the control unit 11 of the catalog management node can calculate (estimate) the number of nodes belonging to each group (a group having node ID of which top digit is “0”, a group having node ID having a top digit of “1”, a group having node ID having a top digit of “2”, . . . ) (an approximate number) on the basis of the routing table using a DHT saved by the own node (by occupied ratio of the routing table).

For example, when node IDs are distributed without deviation in one ID space, when the node ID, the IP address and the like are registered in all of the above-mentioned columns of a table of level 1 shown in FIG. 3 (a column corresponding to the own node is included as a registered column), it is calculated that at least 4^{4/4}=4¹=four nodes participate in the overlay network 9. Further, when the node ID, the IP address and the like are registered in all of the above-mentioned columns of tables of level 1 and level 2 shown in FIG. 3, it is calculated that at least 4^{8/4}=4²=16 nodes participate in the overlay network 9. Further, when the node ID, the IP address and the like are registered in all of the above-mentioned columns of a table of level 1 and level 2 shown in FIG. 3 and there are two blank columns in a table of level 3 (normally, columns in a lower level are occupied first), it is calculated that 4^{10/4}=32 nodes participate in the overlay network 9. Therefore, when, for example, the node ID is 16-digit hexadecimal number and node ID, IP address and the like are registered in K columns of the routing table (a column where the own node is registered is included), it is calculated that “16^{K/16}” nodes participate in the overlay network 9. Because the number of groups is 16, from “0” to “F”, a value obtained by dividing “16^{K/16}” by 16 is the number of nodes for each group.

Then, when the top digit of the node ID of the own node is not γ in the above-mentioned Step S74 (Step S74: NO), the control unit 11 determines a node having a node ID having a top digit of γ (for example, 0) (for example, the node A of which node ID is “0132”), and transmits the presentation instruction message thus generated to the node thus determined (Step S79). Then, the process proceeds to Step S80 and the same process as above is performed. Then, by each node which received the presentation instruction message thus transmitted, process shown in Steps S61 to S65 is carried out. As a result, the presentation instruction message is delivered to a node belonging to for example the group γ (=0) (for example, a node having a node ID within a range of “0000” to “0333” in the left upper portion of FIG. 8 (A)). In this case, process in Steps S66 and S68 is also not performed and in the same manner as Step S15 shown in FIG. 15, each node receiving the presentation instruction message sets new content catalog information corresponding to the serial number included in the presentation instruction message to a condition where presentation to a user is enabled.

Thus, remaining groups γ(e.g. 1 and 2) are sequentially selected and the presentation message is delivered to nodes belonging to the group.

As such, when the top digit value of a node ID is set up to be a factor for a grouping condition, a presentation instruction message is delivered only to a node belonging to a group being a delivery target. Therefore, each node need not perform process to judge whether or not a grouping condition is satisfied as shown in Step S66 and the load of the network 8 can also be reduced.

### [4.4 Process by Catalog Management Server Delivering Presentation Instruction Message]

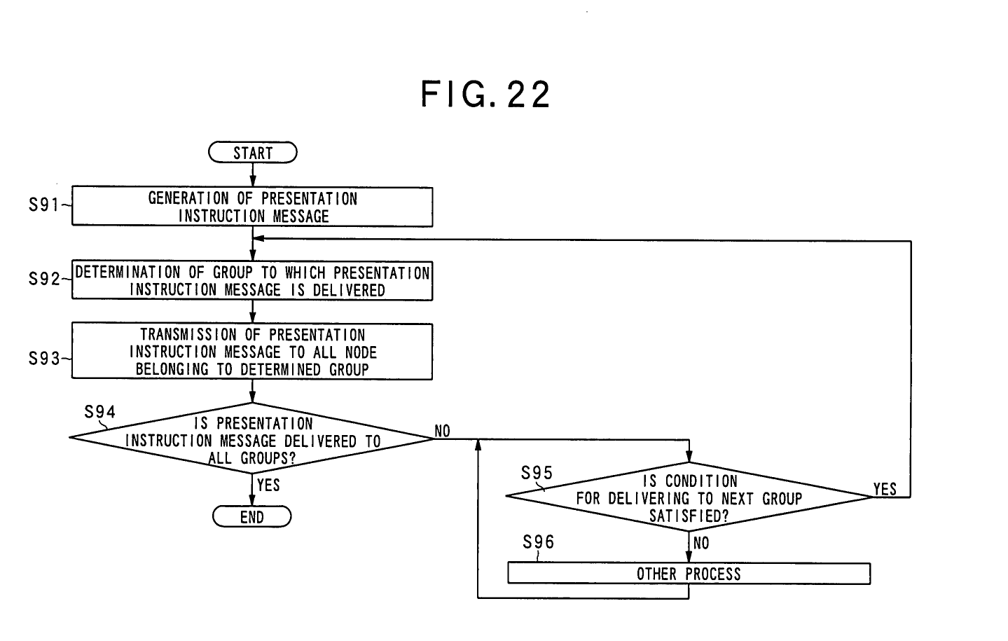

Next, a case where a presentation instruction message is delivered by a catalog management server will be explained with reference to FIG. 22.

FIG. 22 is a flowchart showing presentation instruction message delivery process in the catalog managing server.

The process shown in FIG. 22 starts after the above-mentioned new content catalog information is delivered, for example, immediately after delivery.

Here, the catalog management server saves the above-mentioned grouping condition table in a manner similar to the catalog management node, and further saves node ID, IP address and the like of nodes belonging to each group. Further, information of each node necessary for grouping condition (e.g. installation area of a node (e.g. postal code or telephone number), connection service provider for a node to the network 8 (e.g. AS number), replay time or number of replays of content data of each genre in a node, energisation time of the node, and the like) is saved and such information is acquired from for example a contact node (normally, a plurality of contact nodes are installed) to which each node accesses when participating in the overlay network 9. That is, each node transmits node information necessary for the grouping condition, which is saved at the time when the node accesses a contact node allocated to the node, to the contact node and regarding information which changes after participation into the overlay network 9 (e.g. replay time or number of replays of the content data for each genre, information such as energisation time of the node), such information is at regular intervals transmitted to the contact node. The catalog management server at regular intervals collects information of each node necessary for grouping condition from the contact nodes to reorganize the grouping at regular intervals. Though it is possible that the catalog management server acquires information of each node necessary for the grouping condition, by passing through a contact node, it is possible to reduce load and the like of the catalog management server.

When process shown in FIG. 22 is started, a control unit of the catalog management server generates a presentation instruction message including a serial number for specifying new content catalog information to be a presentation target in for example the payload part (Step S91) and temporarily saves the message.

Next, the control unit of the catalog management server refers to the saved grouping condition table and determines (selects) a group to be a delivery target (Step S92). For example, when the grouping condition table shown in FIG. 17 (A) is used, the group a of which delivery order is the first having “30 hours or more” replay time is selected first (in the first loop). Here, in the Step S92, a method of determining a group by use of a grouping condition table is similar to that in Step S43 shown in FIG. 19. However, when genre is taken into consideration regarding replay time (or number of replays), it is necessary to save, for example, the grouping condition table shown in FIG. 17 (A) for each genre of content data, grouping condition table corresponding to genre (for example, animation) of new content data is referred to and a group to be a delivery target is determined (selected).

Next, the control unit of the catalog management server specifies the IP address or the like of a node belonging to the group thus selected, delivers the presentation instruction message thus generated to the node thus specified (Step S93), and starts counting.

Next, the control unit of the catalog management server judges whether or not the presentation instruction message is delivered to all the groups stipulated in the grouping condition table (Step S94). When the presentation instruction message is not delivered to all the groups (Step S94: NO), the control unit judges whether or not delivery condition for a next group is satisfied (the same as the above-mentioned Step S49) (Step S95).

When delivery condition for a next group is not satisfied (Step S95: NO), the control unit performs other process (Step S96) and returns to Step S95.

On the other hand, when the delivery condition for a next group is satisfied (Step S95: YES), the process returns to Step S92, a next group to be a delivery target of the presentation instruction message (e.g. a group having next longest replay time) is selected and process in Step S93 and following Steps is performed.

Then, when it is judged that the presentation instruction message is delivered to all the groups in the above-mentioned Step S94 (Step S94: YES), the process is finished.

The presentation instruction message thus delivered is received by each node and each of the nodes sets new content catalog information corresponding to a serial number included in the presentation instruction message to a condition where presentation to a user is enabled in the a manner similar to Step S15 shown in FIG. 15.

As described above, when a presentation instruction message is delivered by a catalog management server in such a manner, a node belonging to a group to be a delivery target is specified by the catalog management server side and the presentation instruction message is delivered only to the node. Therefore, each of the nodes need not perform the process of judging whether or not grouping condition is satisfied.

Further, in the above embodiment, explanation is given to a case where the overlay network 9 is constructed by algorithm using DHT. However, the present invention is not limited thereto.

The present invention is not confined to the configurations listed in the foregoing embodiments, but it is easily understood that the person skilled in the art can modify such configurations into various other modes, within the scope of the present invention described in the claims.

What is claimed is:

1. A node device which receives content catalog information, having attribute information of content data, acquirable by each of a plurality of node devices, described in it and being delivered from a delivery device, in an information delivery system that includes the plurality of nodes, the nodes being mutually communicable through a network and divided into a plurality of groups in response to a predetermined grouping condition, the node device comprising:
a new content catalog receiving means for receiving new content catalog information, delivered from the delivery device and having attribute information of new content data to be newly acquirable by each of the node devices;
a new content catalog saving means for saving the new content catalog information thus received;
a condition information saving means for saving condition information indicative of the grouping condition and presentation time information stipulating a presentation time when the new content catalog information is to be presented to a user with respect to each group;
a group judgment means for judging a group, to which the own node belongs, on the basis of the condition information;
a presentation time judgment means for judging whether or not there becomes the presentation time corresponding to a group, to which the own node device belongs, after receiving the new content catalog information on the basis of the presentation time information; and
a content catalog presentation setting means for setting up the new content catalog information thus saved to be in a condition that presentation to a user is enabled in a case where it is judged that there becomes the presentation time corresponding to the group, to which the own node device belongs.

2. The node device according to claim 1,
wherein the condition information and the presentation time information are added to the new content catalog information, delivered by the delivery device.

3. The node device according to claim 1,
wherein node identification information, respectively having unique identification information and including a predetermined digit number, is allocated to each node device;
a grouping condition for dividing the node devices into the plurality of groups in response to a value of a predetermined digit in the predetermined digit number of the node identification information is indicated in the condition information; and
the group judgment means judges the group, to which the own node device belongs, from among groups divided into a plurality of number in response to the value of the predetermined digit on the basis of the condition information.

4. The node device according to claim 1,
wherein a grouping condition for dividing the node devices into the plurality of groups in response to an area of installing each of the node devices is described in the condition information; and
the group judgment means judges the group, to which the own node device belongs, from among groups divided into a plurality of number in response to the area on the basis of the condition information.

5. The node device according to claim 1,
wherein a grouping condition for dividing the node devices into the plurality of groups in response to a connection service provider for each of the node devices to be connected to the network is described in the condition information; and
the group judgment means judges the group, to which the own node device belongs, from among groups divided into a plurality of number in response to the connection service provider on the basis of the condition information.

6. The node device according to claim 1,
wherein a grouping condition for dividing the node devices into the plurality of groups in response to a replay time or number of replays of content data of each of the node devices is described in the condition information; and
the group judgment means judges the group, to which the own node device belongs, from among groups divided into a plurality of number in response to the replay time or number of replays on the basis of the condition information.

7. A node device according to claim 6,
wherein, in the condition information, a grouping condition for dividing node devices into the plurality of groups in response to the replay time or number of replays for each type of content data in each of node devices is described; and
the group judgment means judges the group, to which the own node device belongs, from among groups divided into a plurality of number in response to the replay time or number of replays corresponding to a type same as the new content data on the basis of the condition information.

8. A node device according to claim 6,
wherein the presentation time corresponding to the group having a longest replay time or a largest times of replay is stipulated earliest in the presentation time information.

9. The node device according to claim 1,
wherein a grouping condition for dividing the node devices into the plurality of groups in response to energisation time of each of the node devices is described in the condition information; and
the group judgment means judges the group, to which the own node device belongs, from among groups divided into a plurality of number in response to the energisation time on the basis of the condition information.

10. The node device according to claim 9,
wherein the presentation time corresponding to the group having a longest energisation time is stipulated earliest in the presentation time information.

11. The node device according to claim 1,
wherein a grouping condition for dividing the node devices into the plurality of groups in response to a combination of replay time or number of replays of content data in each of the node devices and energisation time of each of the node devices is described in the condition information; and
the group judgment means judges the group to which the own node device belongs from among groups divided into a plurality of number in response to the combination on the basis of the condition information.

12. The node device according to claim 1,
wherein an interval between the presentation times corresponding to each group stipulated by the presentation time information is set up on the basis of information indicative of an estimated request number which is the number of requesting the new content data by the plurality of node devices and changes in accordance with a lapse of time.

13. An information delivery system including a plurality of node devices, being mutually communicable through a network and dividable into a plurality of groups in response to a predetermined grouping condition, and a delivery device for delivering content catalog information in which attribute information of content data, acquirable by each of the node devices, is described to the plurality of node devices,
wherein the delivery device comprising:
a new content catalog saving means for saving new content catalog information in which attribute information of new content data to be newly acquirable by each of the nodes is described;
a new content catalog delivery means for delivering the new content catalog information to all the node devices; and
a presentation instruction information transmission means for transmitting to the node devices belonging to each of the groups presentation instruction information for presenting a user with the new content catalog information at times different with respect to each of the groups, divided in response to the grouping condition,
wherein the node device comprising:
a new content catalog receiving means for receiving the new content catalog information, delivered from the delivery device;
a new content catalog saving means for saving the new content catalog information thus received;
a presentation instruction information receiving means for receiving the presentation instruction information delivered from the delivery device; and
a content catalog presentation setting means for setting up the new content catalog information thus saved to be in a state of enabled to be presented to the user in a case where the presentation instruction information thus received is bound for the group to which the own node device belongs.

14. A delivery device for delivering content catalog information, in which attribute information of content data acquirable by each of a plurality of node devices is described, to the plurality of node devices in an information delivery system including the node devices, being mutually communicable through a network and dividable into a plurality of groups in response to a predetermined grouping condition, comprising:
a new content catalog saving means for saving new content catalog information in which attribute information of new content data to be newly acquirable by each of the node devices is described;
a new content catalog delivery means for delivering the new content catalog information to all the node devices; and
a presentation instruction information transmission means for transmitting presentation instruction information for presenting a user with the new contents catalogue information to a node device, belonging to each of the groups at times different with respect to each of the groups in response to the grouping condition.

15. The delivery device according to claim 14, further comprising:
a request number information acquisition means for acquiring request number information indicative of number of requests for acquiring the new content data by the plurality of node devices after delivering the new content catalog information,
wherein the presentation instruction information transmission means transmits the presentation instruction message to the node device belonging to the next group in a case where the number of requests indicated in the request number information becomes a predetermined standard number or more.

16. The delivery device according to claim 14, further comprising:
a node number information acquisition means for acquiring node number information indicative of a number of node devices, belonging to each of the groups; and
a request number information acquisition means for acquiring request number information indicative of a number of requests for acquiring the new content data by the plurality of node devices after delivering the new content catalog information,
wherein the presentation instruction information transmission means transmits the presentation instruction message to the node device, belonging to the next group, in a case where the number of requests indicated in the request number information reaches a predetermined ratio of a number of the node devices belonging to the group to which the presentation instruction information is transmitted immediately before.

17. The delivery device according to claim 16,
wherein the presentation instruction information transmission means transmits the presentation instruction message to a node device, belonging to the next group, in a case where the number of requests indicated in the request number information reaches a predetermined ratio of a number of node devices, belonging to a group to which the presentation instruction information is transmitted immediately before, and that a number of the requests per a unit time indicated in the request: number information reduces.

18. A node device for receiving new content catalog information delivered from the delivery device according to claim 14, comprising:
a new content catalog saving means for saving new content catalog information thus received;
a presentation instruction information receiving means for receiving the presentation instruction information delivered from the delivery means; and
a content catalog presentation setting means for setting up the new content catalog information thus saved to a condition where presentation to the user is available when the destination of the presentation instruction information thus received is the group, to which the own node device belongs.

19. A node process program to cause a computer to function as the node device according to claim 1.

20. A delivery process program to cause a computer to function as the delivery device according to claim 14.

21. An information delivery system including a plurality of node devices, enabled to mutually communicate through a network and divided into a plurality of groups in response to a predetermined grouping condition, and a delivery device for delivering content catalog information in which attribute information of content data acquirable by each of the node devices is described to the plurality of node devices,
wherein the delivery device comprising:
a new content catalog delivery means for delivering new content catalog information, in which attribute information of new content data to be newly acquirable by each of the nodes is described, to the plurality of node devices, and
the node device comprising:
a new content catalog receiving means for receiving the new content catalog information;
a new content catalog saving means for saving new content catalog information thus received;
a condition information saving means for saving condition information indicative of the grouping condition and presentation time information in which presentation time for presenting the new content catalog information to a user is stipulated with respect to each group;
a group judging means for judging a group, to which the own node device belongs, on the basis of the condition information;
a presentation time judging means for judging whether or not there becomes the presentation time corresponding to a group, to which the own node belongs, on the basis of the presentation time information after receiving the new content catalog information; and
a content catalog presentation setting means for setting up the new content catalog information thus saved to a condition that presentation to a user is enabled in a case where it is judged that there becomes the presentation time corresponding to the group, to which the own node belongs.

22. An information delivery method of an information delivery system including a plurality of node devices, enabled to mutually communicate through a network and divided into a plurality of groups in response to a predetermined grouping condition, and a delivery device for delivering content catalog information, in which attribute information of content data acquirable by each of the node devices is described, to the plurality of node devices,
wherein, in the delivery device, the information delivery method comprising steps of:
delivering new content catalog information, in which attribute information of new content data to be newly acquirable by each of the nodes is described, to the plurality of node devices, and
in the node device, the information delivery method comprising steps of:
receiving the new content catalog information;
saving the new content catalog information thus received;
saving condition information indicative of the grouping condition and presentation time information in which presentation time for presenting the new content catalog information to a user is stipulated with respect to each group;
judging the group to which the own node device belongs on the basis of the condition information;
judging whether or not there becomes the presentation time corresponding to the group, to which the own node belongs, on the basis of the presentation time information after receiving the new content catalog information; and
setting up the new content catalog information thus saved to a condition where presentation to a user is enabled in a case where it is judged that there becomes the presentation time corresponding to the group, to which the own node belongs.

23. An information delivery method of an information delivery system including a plurality of node devices, being mutually communicable through a network and divided into a plurality of groups in response to a predetermined grouping condition, and a delivery device for delivering content catalog information, in which attribute information of content data acquirable by each of the node devices is described, to the plurality of node devices,
wherein in the delivery device, the information delivery method comprising steps of:
saving new content catalog information, in which attribute information of new content data to be newly acquirable by each of the nodes is described;
delivering the new content catalog information to all the node devices; and
transmitting presentation instruction information for causing the node devices belonging to each of the groups to present the new content catalog information to a user at different times for each of the groups divided in response to the grouping condition, and
in the node device, the information delivery method comprising steps of:
receiving the new content catalog information delivered from the delivery device;
saving the new content catalog information thus received;
receiving the presentation instruction information delivered from the delivery device; and
setting up the new content catalog information thus saved to be in a condition that presentation to the user is enabled in a case where the presentation instruction information thus received is bound for the group, to which the own node device belongs.
